(19) United States
(12) Patent Application Publication
(10) Pub. No.: US 2003/0195653 A1
(43) Pub. Date: Oct. 16, 2003

(54) Fuel dispenser using software agents to facilitate diagnostics and maintenance

(76) Inventors: Tommy W. Lewis, Chesapeake, VA (US); Jonathan Clark, Chesapeake, VA (US)

Correspondence Address: RANDALL J. KNUTH, P.C., 3510-A Stellhorn Road, Fort Wayne, IN, 46815-4631, US

(21) Appl. No.: 10/071,325

(22) Filed: Feb. 7, 2002

Related U.S. Application Data
(60) Provisional application No. 60/334,175, filed on Nov. 29, 2001.

(51) Int. Cl. G06F 17/00

(52) U.S. Cl. 700/236

(57) ABSTRACT

An agent facility monitors and performs management tasks on the fuel dispenser positions of a refueling environment. The agent facility collects event information including dispenser component data, performs diagnostic operations on the component data, and executes maintenance operations according to the results of the diagnostic tests. The diagnostic procedure manipulates event-specific variable information and then employs a rule-based evaluation procedure that applies the manipulated variable information to specific rules associated with the detected event. These rules involve a comparative analysis relative to predetermined reference measures. The rules are implemented in a programmable event table having plural records each associated with a respective event. Each record includes instructions on the type of data processing operation to perform, instructions on the type of evaluation procedure to perform on the processed data, and instructions specifying the type of maintenance operation and/or control operation to perform in response to the outcome of the evaluation.

### CROSS-REFERENCE TO RELATED APPLICATIONS

This application is related to U.S. patent application Ser. No. 09/761,271 entitled “REMOTE MANAGEMENT OF RETAIL PETROLEUM EQUIPMENT” filed Jan. 20, 2000, which is assigned to the same assignee as the present application and is hereby incorporated herein by reference thereto.

### BACKGROUND OF THE INVENTION

1. Field of the Invention

The present invention relates to fuel dispensing facilities and, more particularly, to a method, system and computer program product for use in combination with an agent facility to provide network management of fuel dispenser positions and to facilitate remote management of the refueling environment.

2. Description of the Related Art

Conventional fuel dispensing stations are typically configured with refueling equipment connected to an operator facility over a dedicated line that carries customer transaction information and control commands. An operator facility such as a point-of-sale (POS) terminal is principally configured to process the customer refueling request. Exemplary processing operations include performing an authorization check, compiling a receipt of the completed transaction, and communicating with the customer regarding various other matters, such as supplementing the refueling transaction with the purchase of convenience store merchandise.

However, conventional refueling stations are noticeably lacking in regard to the implementation of management features such as diagnostic and maintenance operations. These exemplary management features are aimed at supporting various administrative tasks essential to maintaining the integrity and operating standards of the refueling activity. For example, it is necessary to monitor the operating status and performance of the refueling equipment to ensure that it is operating properly relative to benchmark requirements. This monitoring data needs to be made available to a suitable diagnostic facility in order to identify device malfunctions and perform other troubleshooting functions such as scheduling maintenance service calls.

Currently, however, such diagnostic procedures require service personnel to physically enter the fuel dispenser cabinet area to gain direct access to the components or to make an interface connection using some form of probe or scan tool that is tethered to the equipment. In either case, on-site personnel must conduct the monitoring activity manually at the equipment location.

Additionally, current monitoring equipment typically exists in an isolated stand-alone configuration; accordingly, the monitoring data cannot be uploaded automatically to a service center for analysis. Service personnel currently must transfer the information retrieved from the refueling devices to a processing facility where a more thorough data analysis can be conducted. This sequence of events results in an extended and piecemeal troubleshooting procedure that limits the ability of service personnel to identify and quickly remedy a problem.

For example, it would be advantageous to activate a maintenance procedure within a time frame proximate to when the diagnostic test results become available. In this manner, the identified problem is not allowed to persist and cause further deterioration of the dispenser environment. Additionally, a control facility would be advantageous in order to enable the implementation of a control operation if it is deemed more beneficial than a maintenance operation.

What is therefore needed is an improved diagnostics functionality that facilitates the execution of diagnostic procedures in an automated, dynamic, and continuous fashion. The diagnostic procedures may be performed locally at the refueling station or at a remote location. The diagnostic facility will also enable monitored component data to be automatically collected. Results of any data evaluation may be uploaded for purposes of arranging maintenance calls. The diagnostic facility will preferably be configured to automatically invoke a maintenance call or control operation in response to the diagnostic test results.

The urgent need for an enhanced diagnostic and maintenance functionality within refueling environments is particularly noteworthy when warranty costs are considered. As known, a typical service station includes multiple dispenser positions each equipped with an increasingly complex array of components, devices, and processes. Accordingly, the economic yield of individual dispenser positions will depend in large measure on the ability to maintain the dispenser components at a highly efficient and reliable working order over a long period of time under extended usage.

Several factors, however, contribute collectively towards diminishing the effective life of a particular component. The ambient environment of the service station may introduce persistent long-term stress into the dispenser equipment. For example, external factors such as extreme temperature, humidity, and other weather-related effects can expose the dispenser equipment to conditions that adversely effect the component performance. Moreover, the repetitive use of the components may introduce failure if the usage exceeds allowable limits.

Every component in the dispenser environment has an associated Mean Time Between Failure (MTBF) value that represents the permissible range or threshold of usage. The following exemplary components have the indicated MTBF values:

card reader electronics—125,000 hours;

card reader head—500,000 passes;

printer electronics—50,000,000 pulses;

printer abrasive—50 km of paper; and

membrane keypad—1,000,000 presses.

These MTBF values, however, normally can only be reached if regular preventative maintenance is performed on the components. Dispenser parts generally cannot reach their expected lifetime of use without some type of maintenance. The problem not yet adequately addressed concerns developing a mechanism for determining when maintenance needs to be performed.

Additionally, even if the MTBF value is not exceeded, it is always possible that components may fail prematurely under various circumstances, such as unexpected environmental conditions, latent design defects, improper installation, and misuse. Accordingly, parts should be supervised regularly (e.g., at periodic intervals), if not continuously, to identify problems and register maintenance visits. It is apparent that diagnostics and maintenance procedures together play a vital role in ensuring the continued integrity of the dispenser arrangement and preserving the serviceable quality of the parts.

It is therefore necessary to establish a diagnostics policy that continuously monitors the condition and performance of the components, even before the MTBF limit has been reached. Additionally, a maintenance program needs to be implemented to complement the diagnostic program so that solutions, repairs, remedies, or other such corrective action can be taken to continue the good working order of the affected part.

Another feature generally absent from standard fuel dispensers involves the ability to selectively regulate dispenser components in a manner governed by the results of diagnostic operations. Such regulation, for example, could involve the modification of a component parameter. Current forms of control are limited to a dedicated control link between the POS terminal and dispenser position requiring manual oversight and manipulation. There is no centralized or automated facility to coordinate, supervise, and manage the control aspects of the various dispenser positions.

It would be advantageous in a refueling station, for example, to allow a programmer or other service personnel to selectively modify the working properties of the refueling equipment, e.g., change the respective flow rates of the fuel pump/valve assembly and vapor recovery apparatus. However, the devices employed in conventional dispenser arrangements typically utilize control routines that are embedded within EPROMs. This configuration essentially makes it impracticable to fix any programming bugs or provide software updates since this would require replacing the existing EPROM with a new EPROM having the desired software module. As a result, designers typically view the on-site refueling equipment as a static configuration incapable of handling updates or accommodating periodic reconfiguration operations.

What is therefore needed is a management facility that enables software-related changes to be made without requiring the physical intervention found in conventional arrangements, thereby enhancing and expanding the software-based functionality.

Additionally, there is needed a network-type management application adapted for integration with the refueling station, which can facilitate and otherwise support network-type operations such as device profile reconfigurations, dynamic updating of the control processes and program instruction sets, and automatic software downloads. One useful function of such managed networks involves the capacity to reconfigure the operating parameters and software processes that run on the managed devices or machines.

In addition to establishing a facility at the refueling environment that is capable of providing localized management functions (e.g., diagnostics), it is also imperative that this feature be integrated with a universal global-type administrator capable of overseeing the entire system of refueling environments. This need has arisen particularly in concert with the rapid globalization of commerce. Commercial expansion into new geographic markets has meant that individual business units such as refueling stations are no longer limited to a single domestic market, but are increasingly being deployed internationally.

For this purpose, it is necessary to develop an administrative capability that enables a central authority to concurrently handle the various management tasks associated with each refueling station. What is therefore needed is a network-wide system manager capable of remotely managing the operations of multiple refueling sites, in collaboration and/or cooperation with the local management functions.

### SUMMARY OF THE INVENTION

According to the present invention there is provided a method, system and computer program product to facilitate various management tasks with respect to the components at fuel dispenser positions. An agent facility employing suitable software processes is configured to monitor the dispenser positions to collect event information, perform diagnostic operations on the component data accompanying the event information, and direct the execution of relevant maintenance operations in response to the results of the diagnostic tests.

In one form, the diagnostic test procedure manipulates event-specific variable information in accordance with the detected event and the associated component data. The variable manipulation is typically implemented as a data processing operation that is performed, for example, on a variable value or a counter value associated with the detected event. In one form, the variable information is provided in the form of a variable table having a plurality of records each associated with a respective event. Each record would also contains pertinent variable values and counter values. The contents of the variable table can be populated in any suitable fashion.

The diagnostic test routine employs a rule-based evaluation procedure or algorithm that applies the manipulated variable information to event-specific rules associated with the detected event. These rules, for example, may involve a comparative analysis relative to predetermined reference measures or other suitable decision-type rules.

In another configuration, the rules are implemented in the form of an event table having a plurality of records each associated with a respective event. Each record includes, for example, instructions on the type of data processing operation to perform and instructions on the type of evaluation procedure to perform on the as-processed data. Additionally, each record includes instructions specifying the type of maintenance operation and/or control operation to perform in response to the outcome or results of the as-completed evaluation.

The agent facility has various advantageous features. For example, the agent facility can be configured as a client machine for use in a client-server architectural model. The variable table and event table are preferably programmable to enable the tables to be selectively and adjustably populated. In this manner, for example, the diagnostic rules can be modified or updated to accommodate changes in the benchmark evaluation criteria.

The agent facility is preferably connected to a remote facility having a management application in order to establish a network management system capable of conducting various remote management tasks and administrative services. The network management functions include tasks such as configuring the fuel dispensing equipment, downloading software updates to the control devices and processor components at the refueling station, monitoring the status and performance of the fuel dispensing equipment in relation to refueling operations, diagnosing and troubleshooting malfunctions and other problems, and scheduling maintenance calls and other servicing activity in response to the diagnostic evaluations.

The remote management application performs its various network management functions in conjunction with a plurality of dedicated software agents each resident at a respective refueling station. Within a network management framework, the fuel dispensing equipment located at the individual refueling stations is viewed by the management application as managed network objects or devices.

The communication links between the agent facility and dispenser positions and between the agent facility and remote management application can use any of various network connections, such as a packet-based network (e.g., Internet) or a high-speed, high-bandwidth communications medium (e.g., Ethernet link) utilizing the standard Transmission Control Protocol/Internet Protocol (TCP/IP).

The invention, in one form thereof, is directed to a system comprising, in combination, a fuel dispenser position having a plurality of components and an agent facility operatively associated with the fuel dispenser position. The agent facility is configured to perform a monitoring function and/or a control function relative to the fuel dispenser position.

In one form, the agent facility is configured further to: (i) receive event information from the fuel dispenser position; (ii) process the event information received from the fuel dispenser position; (iii) evaluate and/or analyze the processed event information; (iv) execute a maintenance task in accordance with the results of the evaluation and/or analysis; (v) execute a control task in accordance with the results of the evaluation and/or analysis; or (vi) perform any combination of steps (i)-(v).

In another form, the agent facility is configured further to: (i) perform a diagnostic operation in relation to event information operatively received from the fuel dispenser position; and/or (ii) perform and/or direct a maintenance operation in relation to the fuel dispenser position, in accordance with the outcome of the diagnostic operation.

In yet another form, the agent facility further includes, in combination, a means to receive event information from the fuel dispenser position; a data facility including a plurality of information elements each associated with a respective event; a processor; and a rules facility. The processor is configured to process at least one information element of the data facility in accordance with the event information received from the fuel dispenser position. The rules facility includes a plurality of rules each associated with a respective event. Each rule respectively defines an evaluation function configured to evaluate the information processed by the processor and/or a tasking function configured to execute at least one task in accordance with results of the evaluation function.

In still yet another form, the agent facility further comprises, in combination, a means to receive event information from the fuel dispenser position; a data facility including a plurality of information elements each associated with a respective event; a processor; and a rules facility. The processor is configured to process at least one information element of the data facility in accordance with the event information received from the fuel dispenser position.

The rules facility includes a plurality of rules each associated with a respective event. Each rule respectively defines: (i) a diagnostic function configured to perform a diagnostic operation in relation to information processed by the processor; (ii) a maintenance call operation configured to perform and/or direct the execution of at least one maintenance task pertaining to the fuel dispenser position, in accordance with the results of the diagnostic operation; (iii) a control operation configured to perform and/or direct the execution of at least one control task pertaining to the fuel dispenser position, in accordance with the results of the diagnostic operation; or (iv) any combination of (i)-(iii).

The system, in one form thereof, further includes a variable table and an event table operatively associated with the agent facility.

The variable table includes a plurality of event-specific records. Each record respectively includes (i) an event indicator indicative of the respective event associated therewith, and (ii) variable information pertaining to the respective event.

The event table includes a plurality of event-specific records. Each record respectively includes at least one of: (i) an event field indicative of an event associated with the record; (ii) an action type field providing instructions defining a data processing operation for performance in conjunction with relevant variable information from the variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

The system, in another form thereof, further comprises a remote facility including a management application. The remote facility is disposed apart from the fuel dispenser position. The management application is configured to enable management of at least one component of the fuel dispenser position in cooperation with the agent facility. A communications link is provided between the agent facility and the remote facility.

The invention, in another form thereof, is directed to a system for use in a refueling environment. The refueling environment comprises a plurality of fuel dispenser positions each having a respective plurality of components. The system includes a management system configured to enable operative management of the refueling environment. The management system includes a management application in combination with an agent facility. The agent facility is operatively arranged in a network management configuration with at least one fuel dispenser position.

In one form, the management application is disposed remote from the refueling environment and the agent facility is disposed within the refueling environment.

The invention, in another form thereof, is directed to an apparatus that includes, in combination, a fuel dispenser position and an agent facility operatively associated with the fuel dispenser position.

In one form, the agent facility further includes, in combination, a means to receive event information from the fuel dispenser position; a diagnostic test program operatively coupled to the receive means; and a maintenance procedure program operatively associated with the diagnostic test program.

In another form, the agent facility further includes, in combination, a means to receive event information from the fuel dispenser position; a data processor operatively coupled to the receive means; and a data analyzer operatively coupled to the data processor.

In yet another form, the agent facility further includes, in combination, a means to receive event information from the fuel dispenser position; a data facility including a plurality of information elements each associated with a respective event; a processor operatively associated with the receive means and the data facility; and a rules facility operatively associated with the processor. The rules facility includes a plurality of rules each associated with a respective event. Each rule respectively including a first set of executable instructions defining an evaluation procedure and a second set of executable instructions defining a management task, the management task including an executable control task and/or an executable maintenance task.

In still yet another form, the agent facility further includes, in combination, a means to receive event information from the fuel dispenser position; a data facility including a plurality of information elements each associated with a respective event; a processor operatively associated with the receive means and the data facility; and a rules facility operatively associated with the processor. The rules facility includes a plurality of rules each associated with a respective event. Each rule respectively includes (i) first program code defining a diagnostic operation, (ii) second program code defining a maintenance operation in relation to the fuel dispenser position, and (iii) third program code defining a control operation in relation to the fuel dispenser position.

The apparatus, in one form, further includes a fuel dispenser control program operatively associated with the agent facility.

The apparatus, in another form, further includes a variable table and an event table operatively associated with the agent facility.

The variable table includes a plurality of event-specific records. Each record respectively includes (i) an event indicator indicative of the respective event associated therewith, and (ii) variable information pertaining to the respective event.

The event table includes a plurality of event-specific records. Each record respectively includes at least one of: (i) an event field indicative of an event associated with the record; (ii) an action type field providing instructions defining a data processing operation involving variable information from the variable table; (iii) a test type field providing instructions defining an analysis operation in conjunction with results of the data processing operation; (iv) a test value field defining a predetermined test value for use in the analysis operation; and (v) an escalation event field providing instructions defining at least one task for execution depending upon the outcome of the analysis operation.

The apparatus, in another form, further includes a remote facility having a management application. The remote facility is disposed apart from the fuel dispenser position. A communications link is provided between the agent facility and the remote facility.

The invention, in another form thereof, is directed to a method for use with a fuel dispenser position in combination with an agent facility. According to the method, the agent facility receives event information from the fuel dispenser position, processes the event information, and then evaluates the processed event information.

In one form, the agent facility executes a maintenance task and/or a control task in accordance with results of the evaluation. Additionally, the agent facility communicates the event information and/or evaluation results to a remote facility disposed apart from the fuel dispenser position.

In another form, the agent facility issues control commands to the fuel dispenser position, in response to at least one directive received from a remote facility disposed apart from the fuel dispenser position. The agent facility may also perform at least one management task in relation to the fuel dispenser position, in response to at least one instruction received from a remote management application disposed apart from the fuel dispenser position.

In one form, the processing step further involves defining event-specific variable information; associating the variable information with the event information; and manipulating the variable information in accordance with the event information. The manipulation step involves adjusting an event-related variable and/or an event-related counter. The event-related variable is indicative of an operating parameter and/or an operating condition of the fuel dispenser position, while the event-related counter is indicative of a count of event occurrence.

In one form, the evaluation step involves determining an allowability of the processed event information in comparative relation to reference information. In an alternative form, the evaluation step may involve performing a rule-based analysis of the processed event information. In a further alternative form, the evaluation step involves the steps of defining a plurality of event-specific rules; detecting an event based upon the event information received from the fuel dispenser position; and applying the processed event information to at least one relevant one of the plurality of event-specific rules as specified by the detected event.

In a yet further alternative form, the evaluation step involves constructing a variable table including a plurality of event-specific records, and constructing an event table including a plurality of event-specific records, each event table record respectively defining an executable evaluation procedure.

Each variable table record respectively includes (i) an event indicator indicative of the respective event associated therewith, and (ii) event-specific variable information pertaining to the respective event.

Each event table record respectively includes at least one of: (i) an event field indicative of an event associated with the record; (ii) an action type field providing instructions defining a data processing operation for performance in conjunction with relevant variable information from the variable table, the data processing operation being used by the event information processing step; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

The method further involves the step of utilizing the event table and the variable table to evaluate the processed event information by associating an event indicated by the event information with a relevant event-specific event table record and executing the corresponding evaluation procedure defined by the relevant event table record.

The invention, in another form thereof, is directed to a method for use with a fuel dispenser position in combination with an agent facility. According to the method, the agent facility receives event information from the fuel dispenser position, and performs a diagnostic test procedure in relation to the event information received from the fuel dispenser position. The agent facility may also perform a maintenance operation and/or a control operation in relation to the fuel dispenser position, in accordance with the results of the diagnostic test procedure performance.

In one form, the diagnostic test procedure involves defining a plurality of event-specific rules; detecting an event based upon the event information received from the fuel dispenser position; and causing at least one relevant one of the plurality of event-specific rules as specified by the detected event to process and/or evaluate the event information.

The rule definition step further involves the steps of constructing a variable table including a plurality of event-specific records, and constructing an event table including a plurality of event-specific records.

In another form, the diagnostic test procedure involves defining event-specific variable information; associating the variable information with the event information; manipulating the variable information in accordance with the event information; and evaluating the manipulated variable information.

The invention, in another form thereof, is directed to a computer program product for use in an agent facility having a computer environment. The agent facility is operatively associated with a fuel dispenser position. The computer program product comprises a computer usable medium having computer readable program code thereon executable by the computer environment. The computer readable program code includes, in combination, a first program code for processing event information operatively received by the agent facility from the fuel dispenser position; and a second program code for evaluating the processed event information.

In one form, the computer readable program code further includes program code for executing a maintenance task and/or a control task relative to the fuel dispenser position, in accordance with the results of the evaluation provided by the second program code.

In another form, the computer readable program code further includes program code for defining a plurality of executable event-specific rules; program code for detecting an event based upon the event information received from the fuel dispenser position; and program code for applying the processed event information to at least one relevant one of the plurality of event-specific rules as specified by the detected event for execution thereof.

The computer program product, in one alternate form thereof, further includes a first data facility including a variable table having a plurality of event-specific records, and a second data facility including an event table having a plurality of event-specific records, each event table record respectively defining an executable evaluation procedure. The second program code further includes third program code for utilizing the event table and the variable table to evaluate the processed event information by associating an event indicated by the event information with a relevant event-specific event table record and then executing the corresponding evaluation procedure defined by the relevant event table record.

Each variable table record respectively includes (i) an event indicator indicative of the respective event associated therewith, and (ii) event-specific variable information pertaining to the respective event.

Each event table record respectively includes at least one of: (i) an event field indicative of an event associated with the record; (ii) an action type field providing instructions defining a data processing operation for performance in conjunction with relevant variable information from the variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

The invention, in another form thereof, is directed to a computer program product for use in an agent facility having a computer environment. The agent facility is operatively associated with a fuel dispenser position. The computer program product comprises a computer usable medium having computer readable program code thereon executable by the computer environment. The computer readable program code includes a first program code for defining and performing a diagnostic test procedure in relation to event information received from the fuel dispenser position.

In one form, the computer readable program code further includes program code for performing a maintenance operation and/or a control operation in relation to the fuel dispenser position, in accordance with the results of the diagnostic test procedure performance provided by the first program code.

In another alternate form, the first program code further includes, in combination, program code for defining a plurality of executable event-specific rules; program code for detecting an event based upon the event information received from the fuel dispenser position; and program code for causing at least one relevant one of the plurality of event-specific rules as specified by the detected event to process and/or evaluate the event information by execution thereof.

In a further alternate form, the first program code further includes, in combination, second program code for defining event-specific variable information; third program code for associating the variable information with the event information; fourth program code for manipulating the variable information in accordance with the event information; and fifth program code for evaluating the manipulated variable information.

The fourth program code may include program code for adjusting an event-related variable and/or an event-related counter. The event-related variable is indicative of an operating parameter and/or an operating condition of the fuel dispenser position, while the event-related counter is indicative of a count of event occurrence.

The computer program product, in one form thereof, further includes a first data facility including a variable table having a plurality of event-specific records, and a second data facility including an event table having a plurality of event-specific records, each event table record respectively defining an executable evaluation procedure. The first program code further includes program code for utilizing the event table and the variable table to process and evaluate the event information by associating an event indicated by the event information with a relevant event-specific event table record and then executing the corresponding evaluation procedure defined by the relevant event table record.

Each variable table record respectively includes (i) an event indicator indicative of the respective event associated therewith, and (ii) event-specific variable information pertaining to the respective event.

Each event table record respectively includes at least one of: (i) an event field indicative of an event associated with the record; (ii) an action type field providing instructions defining a data processing operation for performance in conjunction with relevant variable information from the variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

One advantage of the invention is that the dispenser-based agent facility can continuously monitor the dispenser positions and automatically perform diagnostic test procedures and related maintenance tasks, thereby alleviating service personnel of the responsibility of conducting these operations manually.

Another advantage of the invention is that the agent functionality can be provided in various alternate configurations, such as integrating the agent function as a dedicated position-specific process into each dispenser position for monitoring the component arrangement associated therewith, embedding the agent function as a dedicated component-specific process into each component, or providing a centralized site-specific agent facility responsible for system-wide management of the dispenser positions within a refueling environment.

Another advantage of the invention is that the agent facility can be implemented in the form of well-known software modules having reprogrammable features that enable selective reconfiguration of the rules that define the rule-based evaluation operations incorporated into the diagnostic test procedure, thereby accommodating changes in the benchmark evaluation criteria.

Another advantage of the invention is that the use of an agent facility enables the development of a network-based management system in which the individual dispenser positions are treated as managed objects and the agent facility is linked to a remote facility having a management application, thereby allowing the use of standard management processes such as Simple Network Management Protocol (SNMP).

Another advantage of the invention is that the dispenser components have increased reliability, durability and serviceability since the agent facility ensures that the equipment receives adequate maintenance, thereby controlling warranty and repair costs and improving the economic performance of the refueling environment.

Another advantage of the invention is that the agent facility can serve as a constituent part of a global management system in which a remote facility can supervise, govern, and otherwise coordinate the operations of various dedicated agent facilities belonging to a vast network of refueling environments.

Another advantage of the invention is that the agent facility can be used by a remote management application to remotely perform a variety of management functions, such as monitoring the operating performance and current status of the refueling equipment, downloading software updates and reconfiguration routines, conducting troubleshooting and diagnostic operations based upon equipment data uploaded from the refueling station, scheduling service maintenance jobs in response to the diagnostics evaluation, and coordinating the management tasks in a manner sufficient to enable concurrent handling of the management demands of various refueling stations.

Another advantage of the invention is that standard network management tools may be used since the refueling stations are arranged in a network configuration in which the individual fuel dispensing components (e.g., programmable valve assembly and fuel pump) are recognized as network devices capable of remote management.

A further advantage of the invention is that the management system may be readily adapted for connection to any network (such as the Internet and/or World Wide Web) using well-known network connection tools, thereby enabling access to a virtually unlimited on-line community and network resources (e.g., servers).

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of a refueling environment configuration incorporating a site-specific agent facility, according to one example of the invention;

FIG. 2 is a block diagram illustration of a refueling environment configuration incorporating component-specific agent facilities, according to another example of the invention;

FIG. 3 is a block diagram view of one illustrative component configuration for use with the agent facility architecture shown in FIG. 1, according to another example of the invention;

FIG. 4 is a block diagram view of one illustrative configuration for the agent facility architecture shown in FIG. 1, according to another example of the invention;

FIG. 5 is a block diagram view of another illustrative configuration for the agent facility architecture shown in FIG. 1, according to another example of the invention;

FIG. 6 is a flowchart describing the operation of the present invention; and

FIG. 7 is a block diagram view of a global dispenser management system for networking a centralized system administrator with various refueling environments having dedicated agent facilities, according to another example of the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

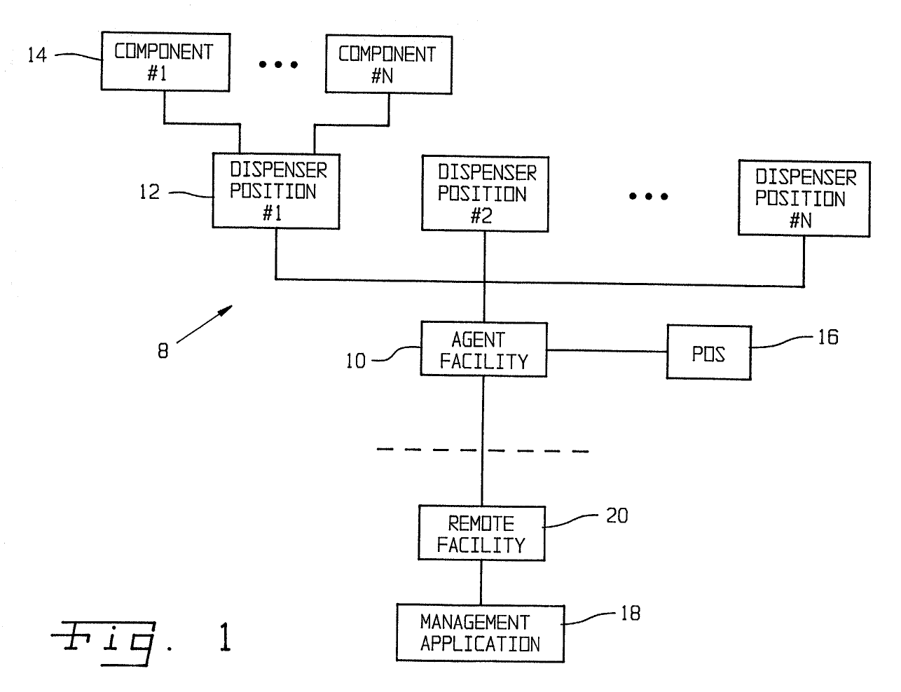

Referring now to the drawings and particularly to FIG. 1, there is shown a block diagram view of a refueling environment 8 incorporating an agent facility 10, according to one example of the present invention.

The illustrated refueling environment 8 conventionally includes an arrangement of illustrative dispenser positions 12 each configured with an array of illustrative components 14. As known to those skilled in the art, each dispenser position 12 is capable of supporting a refueling transaction, such as servicing a vehicle with a selected brand of gasoline according to a customer request. For this purpose, the dispenser position 12 may include any array of components 14 suited to facilitating a refueling transaction. Accordingly, the particular configuration of dispenser-related equipment in refueling environment 8 should not be considered in limitation of the present invention, as it should be apparent to those skilled in the art that any suitable arrangement of fuel dispensing equipment may be utilized.

According to one feature of the invention, the illustrated agent facility 10 is configured for connection to and communication with the arrangement of dispenser positions 12 (and associated components 14). The link between agent facility 10 and dispenser positions 12 will support bi-directional communications, e.g., the transmission and reception of data and control signals.

Agent facility performs a variety of management functions in relation to dispenser positions 12, specifically in regard to monitoring and controlling the associated array of components 14. Additionally, agent facility 10 is coupled to at least one on-site operator facility, such as a point-of-sale (POS) terminal 16. It should be understood, however, that agent facility 10 may be linked to any other entity encompassed by a refueling environment 8, as known to those skilled in the art.

By way of overview, the management operations of agent facility 10 include, but are not limited to, monitoring the status and performance of dispenser positions 12, collecting and otherwise receiving event messages from dispenser positions 12, performing diagnostic tests on event-related information, and directing the execution of corrective action in response to the results of the diagnostic tests. Such corrective action may take the form of a maintenance task or a control task (e.g., regulating the behavior of a dispenser component by adjusting an operational parameter). It should be apparent that the management policy implemented by agent facility 10 may include any set of routines and procedures, especially when agent facility 10 is provided in a computer platform having a reprogrammable feature so that the policy may be changed and/or updated.

As discussed further herein, the management policy implemented by agent facility 10 operates in association with events that occur within refueling environment 8, specifically in connection with individual components 14. The agent facility 10 receives event messages that include an identification of the event and related event-specific information. Agent facility 10 uses the event ID and event-related data to perform the appropriate diagnostic tests and then request suitable corrective action based upon the diagnostic test results.

As shown further by FIG. 1, agent facility 10 coordinates and otherwise handles the various management tasks associated with multiple dispenser positions 12. The various dispenser-specific management tasks are conducted in a parallel fashion that enables agent facility 10 to handle multiple dispenser-specific management jobs concurrently and simultaneously. It appears to each dispenser position 12, then, that agent facility 10 essentially works as a dedicated entity, since the other dispenser management tasks are transparent to the dispenser position and hence not visible.

Agent facility 10 provides a system-wide or site-wide functionality in which the agent-type management tasks associated with dispenser positions 12 are centralized within a single entity, namely, agent facility 10. This centralization enables a single host platform in the form of agent facility 10 to access and manage the dispenser components 14. This further facilitates remote management of the dispenser positions 12 since management application 18 need only communicate with agent facility 10 to access the entire collection of managed objects, i.e., dispenser positions 12.

In one form, agent facility 10 is operatively associated with a management application 18 disposed at a remote facility 20 to form a comprehensive network management system. In this manner, the entire arrangement of fuel dispensing equipment may be recognized and otherwise viewed by management application 18 as a configuration of managed network devices. Accordingly, management application 18 need not be customized, tailored, or specially adapted for use in managing the fuel dispensing equipment. Rather, the present invention permits the use of standard network management tools, modules, and packages. Remote facility 20 is typically disposed apart from refueling environment 8, but may reside at any suitable location.

As part of such a network management system, agent 10 works in cooperation with management application 18 to support remote management of dispenser positions 12. For example, agent 10 may provide assistance to management application 18 in connection with the following functions: issuing maintenance requests to a service center accessible via remote facility 20, uploading diagnostic and monitoring information to management application 18 for further analysis and archival, responding to commands and other requests originating from management application 18 (e.g., instruction for implementing a component reconfiguration), and receiving software downloads to update the software platform of agent 10.

Agent 10, according to one form thereof, represents an abstraction of resources and therefore may be implemented in a variety of conventional ways. For example, agent 10 may be implemented in the form of a routine, algorithm, or process (e.g., software application) or as embedded code (e.g., firmware or logic circuitry). Additionally, agent 10 may be resident in a computing machine, storage facility (e.g., programmable ROM), computer environment, or other suitable means. For example, it may be sufficient to implement agent 10 in a form capable of acting simply as a type of information broker, intermediary, or suitable interface between the network management tool (i.e., management application 18) and the managed devices (i.e., the illustrative equipment depicted in refueling environment 8).

In one exemplary form, agent 10 is configured to support SNMP (Simple Network Management Protocol). As known to those skilled in the art, the SNMP specification defines the manner in which SNMP management applications (such as management application 18)) communicate with SNMP agents to facilitate the transfer and exchange of data, commands, requests, instructions, responses, queries, and other such information in furtherance of carrying out various management functions. A useful reference providing further descriptions of network features may be obtained from “Newton's Telecom Dictionary” by Harry Newton, published by Miller Freeman, Inc., New York, N.Y. (February 1999), incorporated herein by reference thereto.

It should be apparent, however, that the invention may be practiced and otherwise implemented in accordance with any conventional communications and management-type process, protocol, and/or application known to those skilled in the art, in addition to SNMP.

The illustrated management application 18 (and associated remote facility 20) should be understood as encompassing (without limitation thereof) a comprehensive system of procedures, processes, software, equipment, and functions designed to facilitate and otherwise perform various management tasks in relation to refueling environment 8. In one form, management application 18 may be understood as including a software application residing on a computer that manages the network devices (e.g., the hardware/software equipment represented by illustrative components 14) with the assistance of agent 10.

The functions performed by management application 18 may include, but are not limited to, monitoring the operating performance and current status of the refueling equipment using information furnished by agent 10, downloading software updates to agent 10, reconfiguring the fuel equipment via the cooperative assistance of agent 10, conducting troubleshooting and diagnostic operations based upon equipment data uploaded from the refueling station via agent 10, scheduling service maintenance jobs in response to its own diagnostics evaluation or at the request of agent 10 following a diagnostic test performed by agent 10, and otherwise maintaining and controlling any suitable aspects of the refueling station operations. In a preferred form, remote facility 20 will be configured to concurrently handle and coordinate the management tasks pertaining to multiple refueling environments 8.

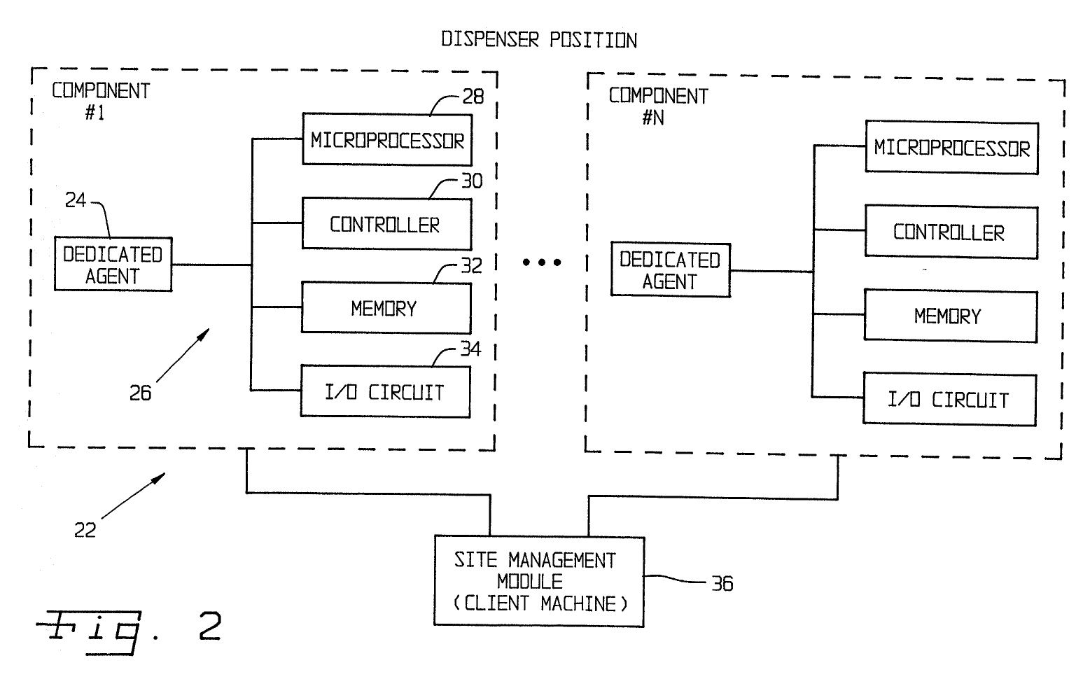

Referring now to FIG. 2, there is shown a block diagram view of an illustrative dispenser position 22 in which the architecture of each dispenser component includes a resident dedicated agent 24, according to another example of the present invention.

The configuration depicted in FIG. 2 represents an alternative arrangement compared to FIG. 1. As discussed above, FIG. 1 shows an arrangement in which a single agent 10 provides centralized management of the multiple dispenser positions 12. In this manner, agent 10 provides a site-wide management function in which it provides management services involving the entire equipment installation of refueling environment 8.

By comparison, the arrangement of FIG. 2 depicts a distributed agent functionality in which every component (or at least one dispenser component) of a dispenser position has an installed dedicated agent 24 configured to provide component-specific management tasks. In terms of its management capabilities, dedicated agent 24 functions similarly to agent facility 10 of FIG. 1.

As shown, dedicated agent 24 is arranged for communication with the illustrated component platform 26 comprising a microprocessor 28, controller 30, memory 32, and I/O circuit 34. Component platform 26 may have any conventional arrangement. Although FIG. 2 depicts the component configuration pertaining to one illustrative dispenser position 22, it should be apparent that the other dispenser positions in the refueling environment may be similarly constructed.

The refueling environment may optionally include a site management module (SMM) 36 configured, for example, as a client machine. SMM 36 serves as an interface between the dispenser positions (specifically, the array of component-specific dedicated agents 24) and a remote facility, such as a server, management application, and/or system administrator. SMM 36 may also be connected to other entities at the refueling environment, such as an operation position (e.g., POS terminal).

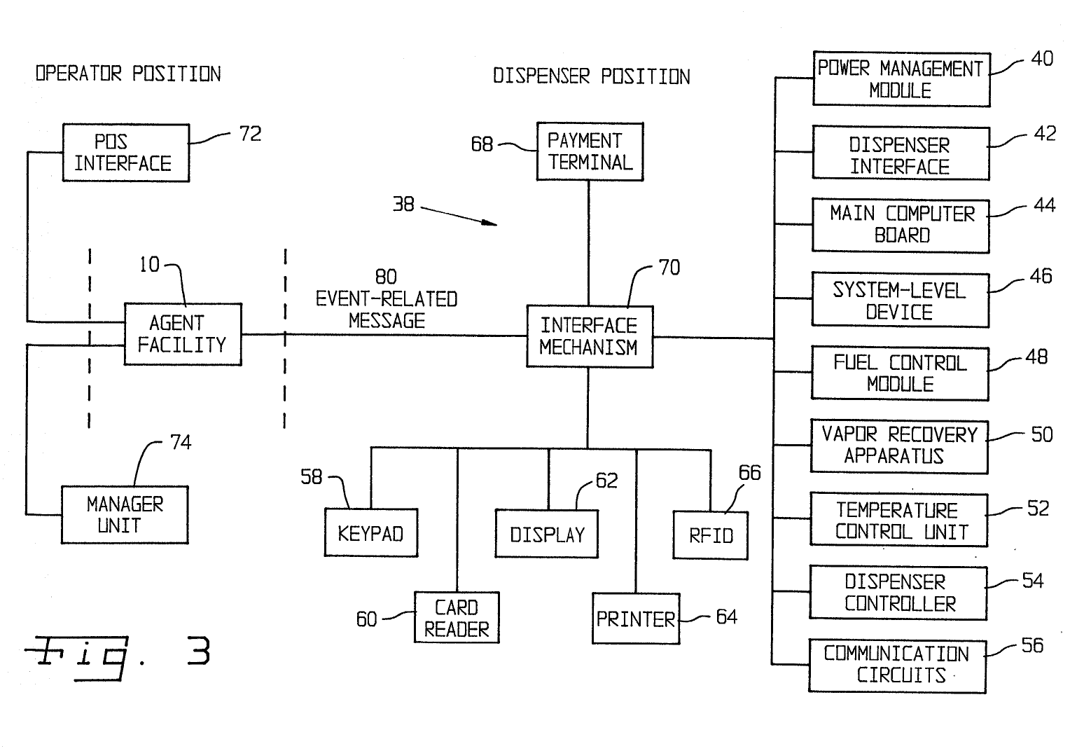

Referring now to FIG. 3, there is shown a block diagram view of one illustrative component configuration for use with the agent facility architecture shown in FIG. 1, according to another example of the invention.

At the dispenser position side, agent facility 10 is connected to a peripheral and dispenser equipment assembly 38 for use in facilitating a fuel delivery transaction requested by a refueling customer. It should be understood that the component configuration represented by assembly 38 is for illustrative purposes only, as it should be apparent that any other components and subassemblies may be installed at the dispenser position and networked to agent facility 10 such that the associated management tasks are governed by agent facility 10.

The illustrated assembly 38 has a conventional form and includes a dispenser-related subassembly including, but not limited to, a power management module 40, a dispenser interface 42 providing a user-compatible interface to the equipment, a main computer board 44 overseeing the computer functions of the dispenser position, a system-level device 46 providing authorized entry and access into secure compartments and facilitating system-wide activation or “boot-up” of the dispenser position, a fuel control module 48, a vapor recovery apparatus 50, a temperature control unit 52 (such as ATC probes), a dispenser controller 54, and various communication circuits 56 needed to suitably interconnect the devices according to conventional requirements.

Assembly 38 may also include various auxiliary or peripheral components including, but not limited to, a keyboard or keypad 58, a card reader 60 to communicate with data-encoded cards (e.g., credit or debit cards), a display 62, a printer 64, and a radio frequency identification device (RFID) 66 configured as a transceiver, for example, to enable the transfer of data between a customer transceiver and a dispenser transceiver over a wireless link.

Assembly 38 may also include a conventional user-interactive payment terminal 68 enabling a customer to request a refueling operation, select the form of payment, submit payment information, select the type/grade/amount of fuel, make non-fuel merchandise purchases, and respond to queries made by POS personnel.

A suitable interface mechanism 70 of conventional form may optionally be used to facilitate a connection between the various devices of component assembly 38 and the platform on which agent facility 10 is implemented. For example, interface mechanism 70 may include an appropriate bus topology and suitable interface circuits to connect component assembly 38 to agent 10 when a computer environment hosts the architecture for agent 10.

At the operator position side, agent 10 may be connected to a POS interface 72 configured within a POS terminal environment. Agent 10 may also be connected to a manager unit 74 that provides, for example, centralized and site-wide point-of-sale functions for the refueling environment. For example, manager unit 74 may compile transaction histories for all of the dispenser positions and receive software downloads for distribution to the operator positions (e.g., POS terminals) via agent 10.

According to one feature of the invention, agent 10 monitors the components and devices within the refueling environment (i.e., at the operator position side and dispenser position side) to detect the presence of events occurring within or in conjunction with the relevant dispenser positions and POS terminals. Indications and other such representations of these events are communicated to agent 10 in the form of event-related messages 80.

As used herein, such event-related messages should be understood as encompassing any communication received from the dispenser position that includes an indication of an event and/or information pertaining to the event. The event indicator may take any suitable form. For example, a code recognizable by agent 10 may be transmitted to agent 10. The code would represent a corresponding condition or state of the relevant machine, i.e., component.

The event code would typically be accompanied by event information representative of the event. For example, if an event code indicates the occurrence of an event (e.g., low power), the associated event data would represent the value of an event-related parameter (e.g., the actual value of the power supply output). The manner of transmitting this information to agent 10 may be accomplished by any means known to those skilled in the art.

Additionally, an event indicator may simply be represented by or otherwise embodied within event-related data. For example, in the case above, the receipt of a parameter value such as power supply output may be followed by a preliminary value examination to determine that an event has occurred, namely, a low power condition. Thus, the parameter value itself constitutes or otherwise reveals an event occurrence.

The receipt and collection of event-related messages may take place in any manner known to those skilled in the art. For example, agent 10 may interactively monitor the status, performance, and working order of the components on any temporal basis, such as continuously, periodically, and/or regularly at specified intervals. In this manner, agent 10 actively engages the dispenser position components in order to monitor the refueling environment for the occurrence of events. For example, agent 10 may conduct a polling process or otherwise interrogate the dispenser position to query whether any monitorable events have occurred. If so, agent 10 requests the transmission of the relevant event message.

Alternately, the dispenser position components may be programmed or otherwise configured to automatically transfer event messages to agent 10 following the occurrence of an underlying event, without any prompting from agent 10.

For purposes of communicating event messages to agent 10, the dispenser position components will be equipped with suitable facilities well known to those skilled in the art to enable event indicators and event-related data to be conveyed to agent 10, either on its own initiative or upon request. For example, a suitable software process may be adapted to form an event message by compiling an event indicator with event-related data once an event has occurred. The components will also be equipped with appropriate facilities to detect when an event has occurred. As used herein, an event should be considered, without limitation thereof, as any circumstance, scenario, condition, and/or situation capable of occurring in association with the refueling environment. The characteristic definition of an event may be user defined and therefore modifiable. For example, a low power supply condition may be defined in terms of a relevant voltage value falling below a threshold condition or otherwise not meeting certain specified criteria. The definition of this event, however, may be changed by adjusting the threshold voltage value. This modification can be implemented according to any means known to those skilled in the art, such as reprogramming user-defined event definitions that are represented in program code instructions.

Furthermore, an event occurrence may be defined in relation to various features, aspects, attributes, and/or characteristics of the refueling environment. For example, an event occurrence may be associated with a configuration, status, condition, behavior, input/output variables, operating parameter, performance parameter, or any combination thereof relative to a machine and/or process. Additionally, events may be defined as multi-dimensional scenarios in which multiple sub-events must occur to produce a specified parent event.

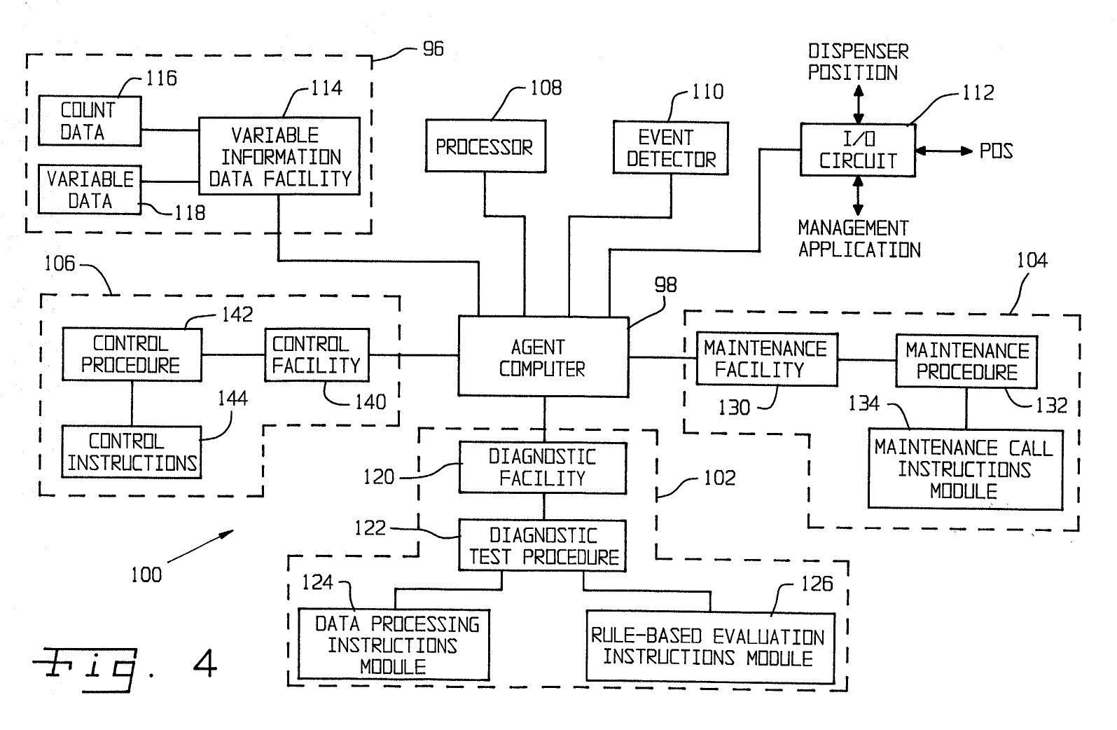

Referring now to FIG. 4, there is shown a block diagram view of an agent architecture 100 for implementing agent facility 10 of FIG. 1, according to another example of the present invention.

The illustrated agent architecture 100 includes an agent computer 98, a diagnostic unit 102, a maintenance unit 104, a control unit 106, and a data unit 96. Agent architecture 100 further includes a processor 108, an event detector 110, an I/O circuit 112, and a variable information data facility 114 including count data 116 and variable data 118. Any combination of hardware, software, firmware, and logic circuitry can be used to implement agent architecture 100. The illustrated diagnostic unit 102 includes a diagnostic facility 120, a diagnostic test procedure 122, a data processing instructions module 124, and a rule-based evaluation instructions module 126. Diagnostic unit 102 generally functions to perform an event-specific diagnostic test procedure in response to event information received from a fuel dispenser position. For this purpose, diagnostic test procedure 122 defines a plurality of diagnostic routines each associated with a respective event. These routines, for example, can be implemented in the form of suitable software code.

In one form, each event-specific diagnostic routine represented in diagnostic test procedure 122 is defined by an initial data processing operation followed by an evaluation operation. For this purpose, diagnostic test procedure 122 includes a first software code subassembly (i.e., data processing instructions module 124) and a second software code subassembly (i.e., rule-based evaluation instructions module 126) to furnish instructions capable of executing data manipulation operations and evaluation operations, respectively.

Diagnostic facility 120 provides a suitable interface with agent computer 98 and facilitates execution of appropriate diagnostic test routines as determined by the event indicator. For this purpose, diagnostic facility 120 will be configured to direct operation of diagnostic test procedure 122 (and hence modules 124 and 126) such as by invoking or otherwise calling the appropriate event-specific test routine embodied in diagnostic test procedure 122.

Regarding module 124, various data processing operations are represented in data processing instructions module 124 for use in conducting a diagnostic test. For example, in combination with data unit 96, data manipulations can be performed on count data 116 and variable data 118 associated with variable information data facility 114. For this purpose, data unit 96 is constructed with event-specific variable information defined by count data 116 and variable data 118.

In one form, count data 116 represents event-specific counter values that are adjusted (e.g., reset, incremented, decremented) according to the specified data processing instructions of the relevant diagnostic test routine. Variable data 118 represents event-specific variable values that are adjusted according to the specified data processing instructions of the relevant diagnostic test routine. For example, adjustment of the variable values will typically take place as a function of the event-related data received as part of the event message.

The data processing operations and evaluation operations involve standard computational functions. Each diagnostic test routine will therefore apply certain event-specific input data (i.e., event-specific variable information) to selected combinations of data manipulation operations to yield event-specific manipulated data that is then evaluated.

Regarding module 126, various evaluation procedures are represented in rule-based evaluation instructions module 126 for use in conducting a diagnostic test. Module 126 defines a plurality of decision-type rules that evaluate the manipulated data provided in connection with the execution of processing operations defined by module 124. Generally, each rule represents some form of comparative analysis that evaluates the processed data in relation to certain specified evaluation criteria. The evaluation criteria, for example, can take the form of threshold values, allowable ranges, and permissible deviations from a reference point. In one form, the evaluation criteria is event-specific.

In one form, each decision-type rule is expressed in the form of an IF-THEN statement that determines whether a certain specified condition has occurred (i.e., the IF part of the rule) and directs the execution of an action (i.e., the decision specified in the THEN clause) when the conditional clause (IF part) is true. The IF part of the statement involves the evaluation and/or analysis computations regarding the processed data. In one form, the decisions rendered by the IF-THEN statement may relate to the execution of a maintenance-related task by maintenance unit 104 and/or a control-related task by control unit 106.

The illustrated maintenance unit 104 includes a maintenance facility 130, a maintenance procedure 132, and a maintenance call instructions module 134. Maintenance unit 104 functions generally to perform an event-specific maintenance task or procedure in response to the results of the diagnostic tests performed by diagnostic unit 102. In particular, diagnostic unit 102 provides a procedure call to maintenance unit 104 that directs unit 104 to execute a specified maintenance task. This procedure call, for example, may occur as part of the THEN-clause decision made in relation to the IF-THEN rules of module 126.

For this purpose, maintenance procedure 132 is provided to define a plurality of executable maintenance tasks each associated with a respective event. These routines, for example, can be implemented in the form of suitable software code, such as the code represented by maintenance call instructions module 134. Module 134 includes a plurality of event-specific program code modules each dedicated to the execution of a specific maintenance task related to a particular event.

The various maintenance tasks may include, but are not limited to, issuing a request for maintenance services (such as to a remote management application or call center), issuing a command to the dispenser position to perform a software-related maintenance operation (such as running a computer scan on a component to check for viruses or other irregularities), or other similar operations.

Maintenance facility 130 provides a suitable interface with agent computer 98 and facilitates execution of appropriate maintenance tasks as determined by maintenance directives received from diagnostic unit 102. For this purpose, maintenance facility 130 will be configured to direct operation of maintenance procedure 132 (and hence instructions module 134) such as by invoking or otherwise calling the appropriate event-specific maintenance routine embodied in elements 132, 134.

The illustrated control unit 106 includes a control facility 140, a control procedure 142, and a control instructions module 144. Control unit 106 functions generally to perform an event-specific control task or procedure in response to the results of the diagnostic tests performed by diagnostic unit 102. In particular, diagnostic unit 102 provides a procedure call to control unit 106 that directs unit 106 to execute a specified control task. This procedure call, for example, may occur as part of the THEN-clause decision made in relation to the IF-THEN rules of module 126.

For this purpose, control procedure 142 is provided to define a plurality of executable control tasks each associated with a respective event. These routines, for example, can be implemented in the form of suitable software code, such as the code represented by control instructions module 144. Module 144 includes a plurality of event-specific program code modules each dedicated to the execution of a specific control task related to a particular event.

The various control tasks may include, but are not limited to, issuing a control command to the fuel dispenser position to vary a component parameter, issuing a control command to the fuel dispenser position to facilitate a component reconfiguration, or otherwise regulating or controlling the behavior of a dispenser component. Control commands may also affect the status of certain components, such as enabling/disabling or activating/deactivating.

Control facility 140 provides a suitable interface with agent computer 98 and facilitates execution of appropriate control tasks as determined by control directives received from diagnostic unit 102. For this purpose, control facility 140 will be configured to direct operation of control procedure 142 (and hence instructions module 144) such as by invoking or otherwise calling the appropriate event-specific control routine embodied in elements 132, 134.

Processor 108 is provided to facilitate the execution of program code instructions resident in agent architecture 100 and to facilitate the performance of computational operations requested by the various modules of agent architecture 100. For these purposes and others apparent to those skilled in the art, processor 108 will operate in a conventional manner in conjunction with agent computer 98 to execute the various computer-related functions associated with agent architecture 100.

The illustrated event detector 110 can be provided in any suitable means that enables receipt of event messages from the refueling environment, e.g., the fuel dispenser positions and POS terminals. As discussed previously, event messages can be provided in any suitable form that notifies, indicates, or otherwise conveys the occurrence of an event associated with the refueling environment. Event detector 110 will also be capable of processing the event message to extract an event indicator (such as a recognizable event-specific code or event identifier) and event-related information such as component parameter values associated with the event.

The event-related data provided by event detector 110 is then made available to the other elements of agent architecture 100. In particular, the event message information is used by diagnostic unit 102, maintenance unit 104, and control unit 106 to select the proper event-specific operations associated therewith. For example, diagnostic unit 102 would use the event indicator to select the appropriate event-specific diagnostic routine embodied in diagnostic test procedure 122.

The agent architecture 100 communicates with the refueling environment via I/O circuit 112. In particular, I/O circuit 112 can be provided in any suitable means that enables agent architecture 100 to interface and otherwise connect to the various monitored units in the refueling environment, i.e., the dispenser positions and POS terminals. I/O circuit 112 can also provide a network connection to local or remote facilities, such as the Internet, World Wide Web, and a remote management application. Outgoing communications from agent architecture 100 also travel by way of I/O circuit 112. Examples of such communications would include dispenser control commands issued by control unit 106 and maintenance commands issued by maintenance unit 104.

Briefly, during one exemplary operation, event detector 110 receives an event message from a fuel dispenser position via I/O circuit 112. The event indicator (i.e., event ID) and event-related data is transferred to diagnostic unit 102 via agent computer 98. In response, diagnostic unit 102 uses the event ID to select the appropriate event-specific diagnostic routine among the plurality of routines defined by diagnostic test procedure 122. In concurrent fashion, the appropriate event-specific variable information for use by diagnostic unit 102 is retrieved from data unit 96.

Diagnostic unit 102 then applies the event-specific variable information (retrieved from data unit 96) and the event-related data (received as part of the event message) to the selected diagnostic routine. The results of the executed diagnostic routine correspond to a rendered decision, which represents what action is to take place. In particular, diagnostic unit 102 issues a directive either to maintenance unit 104 and/or control unit 106. The appropriate unit 104, 106 receives the directive and uses the event ID provided by event detector 110 to retrieve and execute the appropriate program code instructions corresponding to the specified maintenance action and/or control action.

Further event messages may be received and processed by agent architecture 100 in a similar manner.

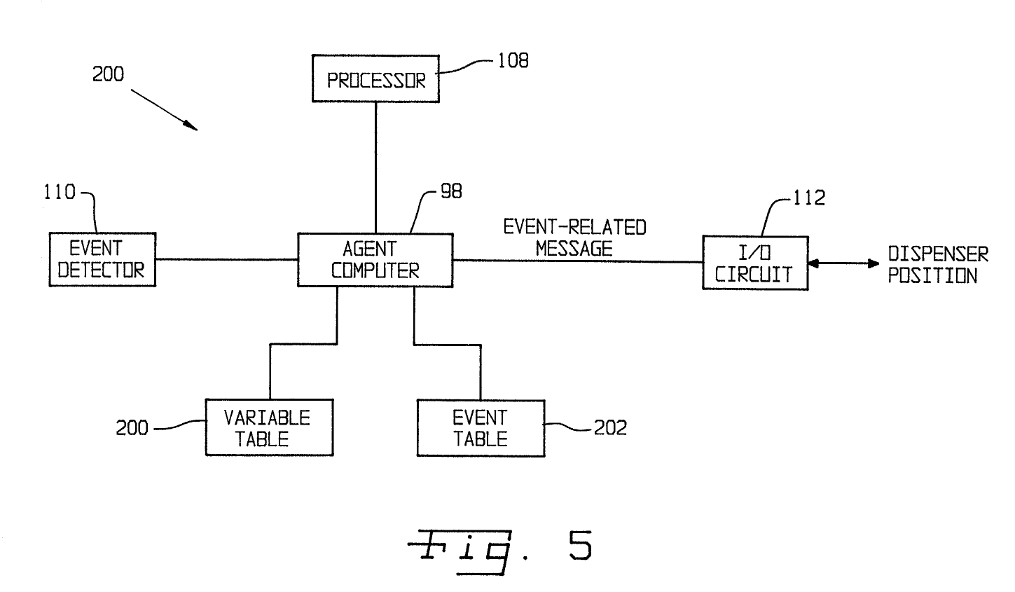

Referring now to FIG. 5, there is shown a block diagram view of an agent architecture 200 for implementing agent facility 10 of FIG. 1, according to another example of the present invention.

The illustrated agent architecture 200 includes a preventative maintenance variable table (PMVT) 200 and a preventative maintenance event table (PMET) 202. The other elements of agent architecture 200 have a similar structure and functionality in relation to the same-numbered elements depicted in the agent architecture 100 of FIG. 4. Both variable table 200 and event table 202 are provided in the form of record-based entities in which each record corresponds to a respective event.

In general, event table 202 fully defines the event-specific diagnostic routines and corrective action routines (e.g., maintenance calls and control calls) for monitoring and responding to events occurring in the refueling environment. In this regard, event table 202 incorporates and otherwise consolidates the functionalities and data structures pertaining to diagnostic unit 102, maintenance unit 104, and control unit 106 in the agent architecture of FIG. 4.

Furthermore, variable table 200 fully defines the event-specific variable information for use in conjunction with the diagnostic routines embodied in event table 202. In this regard, variable table 200 incorporates and otherwise consolidates the functionalities and data structures pertaining to data unit 96 in the agent architecture of FIG. 4.

As discussed below, event table 202 and variable table 200 work together in a collaborative and cooperative relationship to determine the manner in which component data is collected and analyzed and to establish what action to undertake after the analysis is completed. Stated otherwise, for example, the agent architecture 200 uses a software-based agent to facilitate the diagnostics and maintenance activity pertaining to the refueling environment.

The discussion below regarding variable table 200 pertains to Table 1. The discussion below regarding event table 202 pertains to Tables A and B in conjunction with Tables 2 and 3.

Preventative Maintenance Variable Table

Variable table 200 is a collection of data records each containing data corresponding to a monitored event. More than one record can exist for a monitored event. However, for each record in the variable table, there must be at least one record in event table 202 to dictate how the variable table data is to be manipulated.

The variable information represented by variable table 200 represents the data that is processed or otherwise manipulated by the diagnostic routine pertaining to the detected event. As discussed below in relation to event table 202, the specific diagnostic test for processing the variable information is identified by the ACTION TYPE field in the relevant event-specific record of event table 202.

The variable information of table 200 is subdivided into two types: counter information and variable information. The manipulation of counter information includes, but is not limited to, resetting a counter value and incrementing/decrementing a counter value in step-wise units.

A description follows of the six (6) individual fields depicted in the illustrative variable table 200 set forth below in Table 1. The indicated format is shown for illustrative purposes only and can be provided in any suitable format or structure.

TABLE 1
VARIABLE TABLE

| | | | | | TRIP |
|---|---|---|---|---|---|
| EVENT | TIME | COUNT | VALUE | TRIP COUNT | VALUE |
| <event | <time | <counter> | <variable> | <counter> | <variable> |
| code> | indicator> | | | | |

Event Code

This field (column 1) contains a code that identifies a certain system event subject to monitoring. The variable table 200 will use the same event codes as employed by event table 202. This common code usage facilitates rapid access and searching of the variable table and proper identification of the event-specific record being invoked by the diagnostic routine, i.e., as requested by the ACTION TYPE field of the event table.

Depending upon the contents of the corresponding event table record, there may be multiple records in the variable table having the same event code. Such a situation would arise, for example, when an event is fully characterized only with the use of multiple parameters. In this case, a proper diagnosis of the event requires the simultaneous processing of multiple variables retrieved from the variable table.

Time

The contents of this field (column 2) indicate the last time that this record was altered. An absolute or relative time measure can be used.

Count

This field (column 3) contains a counter that reflects the results of a count-type action performed by the agent facility pursuant to a count-related diagnostic test.

Referring to Table 2, the diagnostic routines employing a count-type operation are indicated by the following function call designators:

PMET_ACTION_TYPE_ADD_COUNT;

PMET_ACTION_TYPE_SET_COUNT; and

PMET_ACTION_TYPE_MULTIPLE_ADD_COUNT.

This field will not reset when the associated event is escalated.

Value

This field (column 4) contains a variable that reflects the results of a variable-type action performed by the agent facility pursuant to a variable-related diagnostic test. Generally, such variable-related tests will involve replacement or adjustment of the contents of the VALUE field.

Referring to Table 2, the diagnostic routines employing a count-type operation are indicated by the following function call designators:

PMET_ACTION_TYPE_ADD_VALUE;

PMET_ACTION_TYPE_SET_MAX_VALUE;

PMET_ACTION_TYPE_SET_MIN_VALUE;

PMET_ACTION_TYPE_SET_VALUE; and

PMET_ACTION_TYPE_MULTIPLE_ADD_VALUE.

This field will not reset when the associated event is escalated.

Trip Count

Similar to the COUNT field, this field (column 5) contains a counter that reflects the results of a count-type action performed by the agent facility pursuant to a count-related diagnostic test. However, depending upon the contents of the escalation reset flag field in the event table, and unlike the COUNT field, this field can reset when the event is escalated.

Like the COUNT field, this field is typically used to maintain a running accumulated count of an event. However, the trip count is reset once the event is escalated, e.g., when a benchmark evaluation criteria has been reached and a maintenance call has been invoked. For example, an escalation event may occur when the number of card reader accesses has reached a predetermined threshold and a cleaning operation has been requested. At this point, the TRIP COUNT is reset to reflect the renewed condition of the card reader and begin anew a running count of the access attempts.

Trip Value

Similar to the VALUE field, this field (column 6) contains a variable that reflects the results of a variable-type action performed by the agent facility pursuant to a variable-related diagnostic test. However, depending upon the contents of the escalation reset flag field in the event table, and unlike the VALUE field, this field can reset when the event is escalated.

Like the VALUE field, this field is typically used to maintain the value of a variable, such as a component parameter. However, the trip value is reset once the event is escalated, e.g., when a benchmark evaluation criteria has been reached and a maintenance call has been invoked.

For example, an escalation event may occur when the total number of printer electronic pulses (since the last scheduled maintenance call) reaches a predetermined threshold, thereby triggering a new maintenance operation request. The running total of pulses would be accumulated, for example, using the PMET_ACTION_TYPE_ADD_VALUE action type (see event table), in which the agent facility is furnished with interim pulse count totals at regular periodic intervals. The interim pulse count is then used to update the current total pulse count, i.e., the interim count is added to the stored count to arrive at a new updated count.

At this point, when the diagnostic operation indicates that the number of pulses has exceeded a certain level and a maintenance call has presumably been completed, the TRIP VALUE is reset to reflect the renewed condition of the component (i.e., printer) and begin anew a running measure of the pulse total.

Preventative Maintenance Event Tables

The following discussion sets forth the various event tables associated with performing diagnostic operations in connection with the event information received from the refueling environment. Tables A and B respectively describe the event tables pertaining to two exemplary diagnostic programs. Event table 202 is initialized with records that reflect the events to be monitored.

The first diagnostic procedure monitors events concerning three (3) principal functional areas, namely, power management (Table A-1), POS interface (Table A-2), and dispenser interface (Table A-3). These tables collectively form one configuration of event table 202 to implement a corresponding diagnostic program, according to one example of the invention.

The second diagnostic procedure monitors events concerning seventeen (17) principal functional areas, namely, power management, main board, system, fuel control, vapor recovery, temperature control, communications, magnetic card reader, keypad, printer, real-time display, VGA display, cash acceptor, debit module, RFID, manager mode, and manager's key arming device. These functional areas are represented respectively in Tables B-1 through B-17. These tables collectively form another configuration of event table 202 to implement a corresponding diagnostic program, according to another example of the invention.

Each event table record includes the following fields: EVENT, ACTION TYPE, INTERVAL, TEST TYPE, TEST VALUE, TEST EVENT, ESCALATION EVENT, ESCALATION E-MAIL FLAG, and ESCALATION RESET FLAG. A discussion of the ACTION TYPE field is provided in conjunction with Table 2. A discussion of the TEST TYPE field is provided in conjunction with Table 3.

TABLE A-1
POWER MANAGEMENT

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| POWER LOSS | | | | | | | | |
| LOW AC | | | | | | | | |
| VOLTAGE IN | | | | | | | | |
| LOW AC | | | | | | | | |
| CURRENT IN | | | | | | | | |
| LOW VOLTAGE + | | | | | | | | |
| 24 V POWER | | | | | | | | |
| SUPPLY | | | | | | | | |
| LOW VOLTAGE + | | | | | | | | |
| 12 V POWER | | | | | | | | |
| SUPPLY | | | | | | | | |
| LOW VOLTAGE + | | | | | | | | |
| 5 V POWER | | | | | | | | |
| SUPPLY | | | | | | | | |

TABLE A-2
POS INTERFACE

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Received NAK | | | | | | | | |
| Received | | | | | | | | |
| Cancel | | | | | | | | |
| Received CRC | | | | | | | | |
| Error | | | | | | | | |
| Received | | | | | | | | |
| Invalid | | | | | | | | |
| Message Type | | | | | | | | |
| Received | | | | | | | | |
| Sequence | | | | | | | | |
| Number Error | | | | | | | | |
| Received Out- | | | | | | | | |
| of-Range | | | | | | | | |
| Value | | | | | | | | |
| Message | | | | | | | | |
| Timeout | | | | | | | | |
| Transmitted | | | | | | | | |
| NAK | | | | | | | | |
| Transmitted | | | | | | | | |
| Cancel | | | | | | | | |
| Retransmitted | | | | | | | | |
| Message | | | | | | | | |
| Transmit | | | | | | | | |
| Buffer | | | | | | | | |
| Overflow | | | | | | | | |
| Receive | | | | | | | | |
| Buffer | | | | | | | | |
| Overflow | | | | | | | | |
| Encryption | | | | | | | | |
| Error | | | | | | | | |
| ICR Reset | | | | | | | | |
| Requested | | | | | | | | |

TABLE A-3
DISPENSER INTERFACE

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Received NAK | | | | | | | | |
| Received | | | | | | | | |
| Cancel | | | | | | | | |
| Received CRC | | | | | | | | |
| Error | | | | | | | | |
| Received | | | | | | | | |
| Invalid | | | | | | | | |
| Message Type | | | | | | | | |
| Received | | | | | | | | |
| Sequence | | | | | | | | |
| Number Error | | | | | | | | |
| Received Out- | | | | | | | | |
| of-Range | | | | | | | | |
| Value | | | | | | | | |
| Message | | | | | | | | |
| Timeout | | | | | | | | |
| Transmitted | | | | | | | | |
| NAK | | | | | | | | |
| Transmitted | | | | | | | | |
| Cancel | | | | | | | | |
| Retransmitted | | | | | | | | |
| Message | | | | | | | | |
| Transmit | | | | | | | | |
| Buffer | | | | | | | | |
| Overflow | | | | | | | | |
| Received | | | | | | | | |
| Buffer | | | | | | | | |
| Overflow | | | | | | | | |
| Fueling Point | | | | | | | | |
| Online | | | | | | | | |
| Fueling Point | | | | | | | | |
| Offline | | | | | | | | |

TABLE B-1
POWER MANAGEMENT

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Power Loss | | | | | | | | |
| Low AC | | | | | | | | |
| Voltage In | | | | | | | | |
| Low AC | | | | | | | | |
| Current In | | | | | | | | |
| Low | | | | | | | | |
| Voltage + | | | | | | | | |
| 24 V | | | | | | | | |
| Power | | | | | | | | |
| Supply | | | | | | | | |
| Low | | | | | | | | |
| Voltage + | | | | | | | | |
| 12 V | | | | | | | | |
| Power | | | | | | | | |
| Supply | | | | | | | | |
| Low | | | | | | | | |
| Voltage +5 | | | | | | | | |
| V Power | | | | | | | | |
| Supply | | | | | | | | |

TABLE B-2
MAIN BOARD

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| RAM Test | | | | | | | | |
| Failed | | | | | | | | |
| Low Battery | | | | | | | | |
| Critically | | | | | | | | |
| Low Battery | | | | | | | | |
| Head Ambient | | | | | | | | |
| Temperature | | | | | | | | |
| Shutdown | | | | | | | | |
| Notification | | | | | | | | |
| Heater/Fan | | | | | | | | |
| Activation | | | | | | | | |
| Extended | | | | | | | | |
| Setup Switch | | | | | | | | |
| Activation | | | | | | | | |
| Detected New | | | | | | | | |
| Peripheral | | | | | | | | |

TABLE B-3
SYSTEM

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Invalid | | | | | | | | |
| Password | | | | | | | | |
| Entered | | | | | | | | |
| Backdoor | | | | | | | | |
| Password | | | | | | | | |
| Used | | | | | | | | |
| Configuration | | | | | | | | |
| Changed | | | | | | | | |

TABLE B-4
FUEL CONTROL

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| FCM Connected | | | | | | | | |
| FCM | | | | | | | | |
| Disconnected | | | | | | | | |
| Quadrature | | | | | | | | |
| Encoder Input | | | | | | | | |
| Open | | | | | | | | |
| Quadrature | | | | | | | | |
| Encoder Input | | | | | | | | |
| Short | | | | | | | | |
| Quadrature | | | | | | | | |
| Encoder Input | | | | | | | | |
| Disconnected | | | | | | | | |
| Quadrature | | | | | | | | |
| Phase Error | | | | | | | | |
| Limit Exceeded | | | | | | | | |
| Phase 0 | | | | | | | | |
| Quadrature | | | | | | | | |
| Phase Error | | | | | | | | |
| Phase 1 | | | | | | | | |
| Quadrature | | | | | | | | |
| Phase Error | | | | | | | | |
| Common Mode | | | | | | | | |
| Phase Error | | | | | | | | |
| Reverse Flow | | | | | | | | |
| Error | | | | | | | | |
| Phase Count | | | | | | | | |
| Difference | | | | | | | | |
| Blend Product 1 | | | | | | | | |
| Too Slow | | | | | | | | |
| Blend Product 2 | | | | | | | | |
| Too Slow | | | | | | | | |
| Blend Product 1 | | | | | | | | |
| Missing | | | | | | | | |
| Blend Product 2 | | | | | | | | |
| Missing | | | | | | | | |
| Blend Product 1 | | | | | | | | |
| Uncontrollable | | | | | | | | |
| Blend Product 2 | | | | | | | | |
| Uncontrollable | | | | | | | | |
| Blend Product 1 | | | | | | | | |
| Leak | | | | | | | | |
| Blend Product 2 | | | | | | | | |
| Leak | | | | | | | | |
| Maximum | | | | | | | | |
| Fueling Point | | | | | | | | |
| Errors | | | | | | | | |
| Exceeded | | | | | | | | |
| Maximum Bad | | | | | | | | |
| Sales Exceeded | | | | | | | | |
| Quadrature | | | | | | | | |
| Encoder Input | | | | | | | | |
| Reverse or | | | | | | | | |
| Error | | | | | | | | |
| Temperature | | | | | | | | |
| Input Out-of- | | | | | | | | |
| Range | | | | | | | | |
| Start Command | | | | | | | | |
| Received In | | | | | | | | |
| Diagnostics | | | | | | | | |
| Mode | | | | | | | | |
| Diagnostics | | | | | | | | |
| Mode Request | | | | | | | | |
| In Fuel | | | | | | | | |
| Delivery | | | | | | | | |
| Delivery Too | | | | | | | | |
| Small | | | | | | | | |
| Delivery Too | | | | | | | | |
| Large | | | | | | | | |
| FCM DC Self | | | | | | | | |
| Test Failure | | | | | | | | |
| USB FCM Self | | | | | | | | |
| Test Failure | | | | | | | | |
| Maximum Flow | | | | | | | | |
| Rate Exceeded | | | | | | | | |
| EM Totalizer | | | | | | | | |
| Disconnected | | | | | | | | |

TABLE B-5
VAPOR RECOVERY

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| MaxVac | | | | | | | | |
| Connected | | | | | | | | |
| MaxVac | | | | | | | | |
| Disconnected | | | | | | | | |
| MaxVac | | | | | | | | |
| device | | | | | | | | |
| Configured | | | | | | | | |
| MaxVac Error | | | | | | | | |
| Side A | | | | | | | | |
| MaxVac Error | | | | | | | | |
| Side B | | | | | | | | |
| MaxVac | | | | | | | | |
| Miscellaneous | | | | | | | | |
| Error | | | | | | | | |

TABLE B-6
TEMPERATURE CONTROL

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| ATC Device | | | | | | | | |
| Connected | | | | | | | | |
| ATC Device | | | | | | | | |
| Disconnected | | | | | | | | |
| Shorted | | | | | | | | |
| Probe | | | | | | | | |
| Out of | | | | | | | | |
| Temperature | | | | | | | | |
| Range or | | | | | | | | |
| Open Probe | | | | | | | | |
| No Data From | | | | | | | | |
| Probe of a | | | | | | | | |
| Compensated | | | | | | | | |
| Product | | | | | | | | |

TABLE B-7
COMMUNICATIONS

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Error | | | | | | | | |
| Communicating | | | | | | | | |
| with | | | | | | | | |
| Controller | | | | | | | | |

TABLE B-8
MAGNETIC CARD READER

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Card Reader | | | | | | | | |
| Connected | | | | | | | | |
| Card Reader | | | | | | | | |
| Disconnected | | | | | | | | |
| Card | | | | | | | | |
| Inserted | | | | | | | | |
| Card | | | | | | | | |
| Removed | | | | | | | | |
| Track 1 | | | | | | | | |
| Error | | | | | | | | |
| Track 2 | | | | | | | | |
| Error | | | | | | | | |
| Card Read | | | | | | | | |
| Error | | | | | | | | |
| Card | | | | | | | | |
| Inserted | | | | | | | | |
| Incorrectly | | | | | | | | |

TABLE B-9
KEYPAD

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Keypad | | | | | | | | |
| Connected | | | | | | | | |
| Keypad | | | | | | | | |
| Disconnected | | | | | | | | |
| Key Pressed | | | | | | | | |

TABLE B-10
PRINTER

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Printer | | | | | | | | |
| Connected | | | | | | | | |
| Printer | | | | | | | | |
| Disconnected | | | | | | | | |
| Receipt | | | | | | | | |
| Printed | | | | | | | | |
| Receipt Cut | | | | | | | | |
| Paper Low | | | | | | | | |
| Paper Out | | | | | | | | |
| Paper Jam | | | | | | | | |
| Printer | | | | | | | | |
| Error | | | | | | | | |

TABLE B-11
REAL-TIME DISPLAY

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Real Time | | | | | | | | |
| Display | | | | | | | | |
| Connected | | | | | | | | |
| Real Time | | | | | | | | |
| Display | | | | | | | | |
| Disconnected | | | | | | | | |
| Real Time | | | | | | | | |
| Display | | | | | | | | |
| Error | | | | | | | | |

TABLE B-12
VGA DISPLAY

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| VGA Display | | | | | | | | |
| Connected | | | | | | | | |
| VGA Display | | | | | | | | |
| Disconnected | | | | | | | | |

TABLE B-13
CASH ACCEPTOR

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Cash | | | | | | | | |
| Acceptor | | | | | | | | |
| Connected | | | | | | | | |
| Cash | | | | | | | | |
| Acceptor | | | | | | | | |
| Disconnected | | | | | | | | |
| Cash | | | | | | | | |
| Acceptor Not | | | | | | | | |
| Communicat- | | | | | | | | |
| ing | | | | | | | | |
| Stacker | | | | | | | | |
| Removed | | | | | | | | |
| Stacker Full | | | | | | | | |
| Bill Jammed | | | | | | | | |
| Vault Open | | | | | | | | |
| Acceptor | | | | | | | | |
| Cheated | | | | | | | | |
| Bill Escrow | | | | | | | | |
| Indicator | | | | | | | | |
| Bill Stacked | | | | | | | | |

TABLE B-14
DEBIT MODULE

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Debit Module | | | | | | | | |
| Connected | | | | | | | | |
| Debit Module | | | | | | | | |
| Disconnected | | | | | | | | |
| Encryption | | | | | | | | |
| Key Not | | | | | | | | |
| Loaded | | | | | | | | |

TABLE B-15
RFID

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| RFID Device | | | | | | | | |
| Connected | | | | | | | | |
| RFID Device | | | | | | | | |
| Disconnected | | | | | | | | |
| RFID Antenna | | | | | | | | |
| Strength | | | | | | | | |

TABLE B-16
MANAGER MODE

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Status | | | | | | | | |
| (ON/OFF) | | | | | | | | |
| Manager | | | | | | | | |
| Mode ON | | | | | | | | |
| Manager | | | | | | | | |
| Mode OFF | | | | | | | | |

TABLE B-17
MANAGER'S KEY ARMING DEVICE

| | | | | | | | ESCALATION | ESCALATION |
|---|---|---|---|---|---|---|---|---|
| | ACTION | | TEST | TEST | TEST | ESCALATION | E-MAIL | RESET |
| EVENT | TYPE | INTERVAL | TYPE | VALUE | EVENT | EVENT | FLAG | FLAG |
| Status | | | | | | | | |
| (Armed/Unarmed) | | | | | | | | |
| Dispenser | | | | | | | | |
| Armed | | | | | | | | |
| Dispenser | | | | | | | | |
| Unarmed | | | | | | | | |

A description is now provided regarding the record field definitions for event table 202.

Event Code

The events specified in the event field column (column 1) of each of the event tables depicted in Tables A and B relate to monitorable events that can occur in relation to the indicated component.

The illustrative records shown in the event tables of Table A and B include a description of each specified event in the EVENT field. However, it should be apparent that these descriptions are provided for illustrative purposes only, since an implementation of the tables would normally require the insertion of an event-specific code into the EVENT fields in a manner similar to how the EVENT CODE field of the variable table (Table 1) is populated.

Any type of code language, descriptor, terminology, format, or event indicator may be used, provided that the same vocabulary of codewords is used throughout the agent facility environment to identify the same events. For example, the event table and variable table would adopt the same codeword vocabulary to facilitate a correspondence, association, and correlation between table records pertaining to the same event.

Action Type

The contents of this field determine what action the agent facility performs to the variable information records associated with the particular event just received. In general, the actions define various forms of data manipulations or data processing operations performed on event-specific variable information (from variable table 200) in view of event-related data (from the refueling environment), prior to its evaluation. It should be apparent, however, that Table 2 is illustrative and therefore various types of data manipulations other than the ones described in Table 2 can be used in this initial part of the diagnostic test routine.

Table 2 below contains the possible values for this field.

In the ACTION field (column 3) of Table 2, the reference to “count” and “value” refers as appropriate to the contents of the COUNT, VALUE, TRIP COUNT, or TRIP VALUE field in the applicable event-specific record from variable table 200. The reference in the ACTION field to “amount contained in the event” or other similar terminology refers to the event-related data that accompanies the event message received from the refueling environment. In particular, such event-related data is generated by the refueling environment in association with the occurrence or presence of an event.

As shown, the actions enumerated by Values 0-5 relate generally to adjustment of the “count” or “value” in the specified manner. Values 6-7 are directed to the addition of new event-specific records into variable table 200.

In one form, the actions indicated in column 3 are implemented in the form of corresponding executable program code, in a manner capable of practice by those skilled in the art.

TABLE 2
TYPES OF MANIPULATIONS PERFORMED ON VARIABLE TABLE DATA:
CONTENTS OF ACTION TYPE FIELD IN EVENT TABLE

| VALUE | ENUMERATION | ACTION |
|---|---|---|
| 0 | PMET_ACTION_TYPE_ADD_COUNT | Increment count by one. |
| 1 | PMET_ACTION_TYPE_SET_COUNT | Set count to one. |
| 2 | PMET_ACTION_TYPE_ADD_VALUE | Increase value by the amount contained in the event. |
| 3 | PMET_ACTION_TYPE_SET_MAX_VALUE | Set value to the amount contained in the event |
| | | whenever the amount is higher than value. |
| 4 | PMET_ACTION_TYPE_SET_MIN_VALUE | Set value to the amount contained in the event |
| | | whenever the amount is lower than value. |
| 5 | PMET_ACTION_TYPE_SET_VALUE | Set value to the amount contained in the event. |
| 6 | PMET_ACTION_TYPE_MULTIPLE_ADD_COUNT | Increase the number of records associated with the |
| | | event by one. In the new record, set count to one. |
| 7 | PMET_ACTION_TYPE_MULTIPLE_ADD_VALUE | Increase the number of records associated with the |
| | | event by one. In the new record, set value to the |
| | | amount contained in the event. |

Interval

The contents of this field indicate how long the variable table record(s) associated with the current monitored event are valid. The agent facility removes any expired variable records before performing an action. In one form, the unit of measure is minutes and zero indicates that the variable record(s) do not expire.

Test Type

The contents of this field determine what diagnostic test the agent facility performs when a particular event is received. In particular, this field indicates the type of rule-based decision-type evaluation to perform on the variable information that previously underwent manipulation in accordance with the data processing instructions provided in conjunction with the ACTION TYPE field.

Generally, it can be considered that this field provides a function that evaluates, analyzes, and/or interprets information, such as with operations like comparisons and calculations. It should be apparent, however, that Table 3 is illustrative and therefore various types of evaluation procedures other than the ones described in Table 3 can be used in this part of the diagnostic test routine.

Table 3 below contains the possible values for this field.

In the TEST field (column 3) of Table 3, the reference to “count” and “value” refers as appropriate to the contents of the COUNT, VALUE, TRIP COUNT, or TRIP VALUE field in the applicable event-specific record from variable table 200, as currently modified or otherwise adjusted by the prior data manipulation operations associated with the current event.

The reference in the TEST field to “test value” refers to the contents of the TEST VALUE field (discussed below) in the applicable event table record. The reference in the TEST field to “test event code's value” and “test event code's count” refers to the contents of the TEST EVENT field (discussed below) in the applicable event table record.

As shown, it is seen that the TEST field contents take the form of an evaluation-type operation (e.g., compare and calculate) relative to a reference benchmark (e.g., test value and test event codes' value/count), followed by a decision or judgment in the form of an IF-THEN statement. In one form, these test actions are implemented in the form of corresponding executable program code, in a manner capable of practice by those skilled in the art.

TABLE 3
TYPES OF EVALUATION TESTS PERFORMED ON MANIPULATED DATA:
CONTENTS OF TEST TYPE FIELD TEN EVENT TABLE

| VALUE | ENUMERATION | TEST |
|---|---|---|
| 0 | PMET_TEST_TYPE_NONE | Do nothing. |
| 1 | PMET_TEST_TYPE_MAX_COUNT | Compare the count to the test value. If the count is greater |
| | | than or equal to the test value, escalate the event. |
| 2 | PMET_TEST_TYPE_MAX_COUNT_RATIO | Calculate the percentage of count to the test event code's count. |
| 3 | PMET_TEST_TYPE_MAX_VALUE | Compare the value to the test value. If the value is greater |
| | | than or equal to the test value, escalate the event. |
| 4 | PMET_TEST_TYPE_MAX_VALUE_RATIO | Calculate the percentage of value to the test event code's value. |
| | | If the percentage is greater than or equal to the test value, |
| | | escalate the event. |
| 5 | PMET_TEST_TYPE_MIN_COUNT | Compare the count to the test value. If the count is less |
| | | than the test value, escalate the event. |
| 6 | PMET_TEST_TYPE_MIM_COUNT_RATIO | Calculate the percentage of count to the test event code's count. |
| | | If the percentage is less than the test value, escalate the event. |
| 7 | PMET_TEST_TYPE_MIN_VALUE | Compare the value to the test value. If the value is less |
| | | than the test value, escalate the event. |
| 8 | PMET_TEST_TYPE_MIN_VALUE_RATIO | Calculate the percentage of value to the test event code's value. |
| | | If the percentage is less than the test value, escalate the event. |
| 9 | PMET_TEST_TYPE_TIME | This event is escalated whenever the current data and time of |
| | | day match the contents of the test value. |

Test Value

The contents of this field are used by the agent facility while performing the test dictated by the TEST TYPE field. The manner in which the TEST VALUE contents are used is specified by the contents of the TEST TYPE field of the applicable event-specific record.

Test Event

This field contains a code that identifies a system event being monitored. When the agent facility is performing a test that requires a second variable record from variable table 200, the identifier in this field is used to retrieve that record. Reference should be made to the description of the TEST TYPE field to determine which tests require this field.

This field must be non-zero to be a valid identifier.

Escalation Event

This field contains a code that identifies a system event. When the agent facility performs a test that requires an event to be escalated, the contents of this field are used to identify the new escalation event.

This field must be non-zero to be a valid identifier.

In one form, this field contains executable program code instructions to perform a corresponding maintenance or control operation following completion of the diagnostic operation.

Escalation E-Mail Flag

The contents of this field indicate to the agent facility whether or not to send an e-mail notification whenever an event is escalated, such as to a remote management application.

Escalation Reset Flag

The contents of this field indicate to the agent facility whether or not to reset the variable table record(s) whenever an event is escalated.

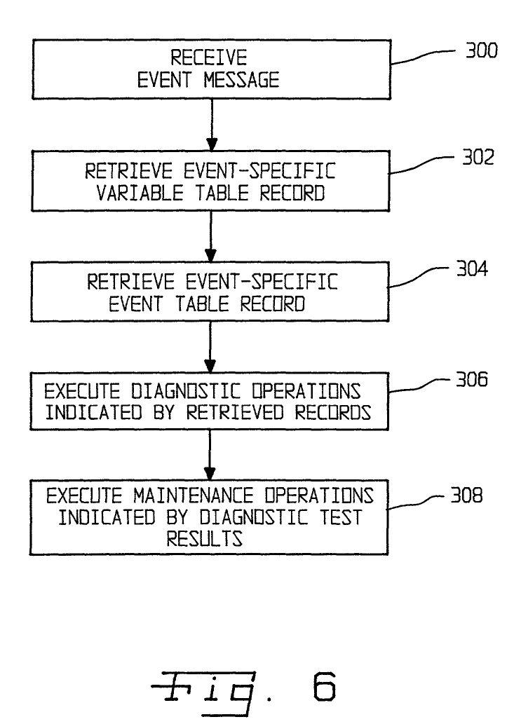

During operation, with reference to FIG. 5 in conjunction with the flowchart of FIG. 6, event detector 110 receives an event message from the refueling environment that indicates the occurrence and/or presence of a monitorable and detectable system event. (Step 300). Event detector 110 supplies an event identifier (ID) representative or indicative of the event. Event detector 110 also supplies any event-related data that accompanies the event message, such as component parameter values.

The event ID supplied by event detector 110 is used by agent computer 98 to identify the applicable event-specific record in event table 202. (Step 304). At the same time, the event ID is also used to identify the applicable event-specific variable record in variable table 200. (Step 302).

Once the appropriate event and variable records have been identified and retrieved, the data processing operation indicated by the ACTION TYPE field of the event table record is performed on the relevant contents of the variable table record. (Step 306). For example, in one form, the relevant diagnostic program code instructions corresponding to and implementing the ACTION TYPE field are loaded into processor 108 and executed. For this purpose, processor 108 would also receive the applicable variable information and event-related data.

Next, the evaluation operation indicated by the TEST TYPE field of the event table record is performed on the as-processed variable information. (Step 306). For example, in one form, the relevant diagnostic program code instructions corresponding to and implementing the TEST TYPE field are loaded into processor 108 and executed. For this purpose, processor 108 would also receive the manipulated data and other necessary inputs needed to exercise the rule, such as the test value and test event codes' count/value.

Depending upon the outcome of the evaluation operation, the event table 202 may indicate the need for an event escalation. (Step 308). In one form, for example, if the IF-THEN rule is satisfied, the relevant maintenance program code instructions corresponding to and implementing the ESCALATION EVENT field are loaded into processor 108 and executed.

Further event messages are similarly received and processed. It is advantageous to configure agent architecture 200 with a reprogrammable feature that enables the contents of variable table 200 and event table 202 to be changed, varied, adjusted, or otherwise modified. This feature is especially beneficial when applied to reconfiguring event table 202 so as to remove, add, or make modifications to the evaluation rules. Additionally, such changes can also be made to the type of data manipulations (i.e., ACTION TYPE field) and the evaluation criteria (i.e., TEST VALUE field).

It should be apparent that the foregoing functions and operations of agent architecture 200 fall under the direction, supervision, coordination, and guidance of agent computer 98 in a conventional manner well known to those skilled in the art.

As an example, routine maintenance must be performed on a card reader during its life or it will not reach the average of 500,000 insertions, for example. This maintenance usually consists of a thorough cleaning. However, there is a problem determining when to schedule the maintenance because card reader usage varies widely within and without the station.

According to the invention, a rule can be created that calculates the ratio of bad card reads versus the total number of card reads to yield a percentage. For this purpose, an event can be defined that relates to the occurrence of a bad card read, as indicated or measured by some criteria. For example, a faulty card read can be indicated by the absence of sufficient retrieved information when the reader scans a card. When this happens, an event message is triggered or otherwise generated that indicates the occurrence of a faulty card read. The accumulated total of bad card reads can be maintained by the agent facility in a relevant variable table record as an updatable count.

Moreover, another related event can be defined that maintains a running count of all card reads, whether good or bad. This allows a comparison of bad card reads to the total number of attempts. For example, an event indicator can be triggered (and a corresponding event message forwarded to the agent facility) when any card reader access is attempted. In this manner, the total number of card reader accesses is maintained. This access total is likewise maintained by the agent facility as a count in the applicable event-specific variable table record.

The exemplary rule that calculates the ratio of bad card reads to the total number of card reads in order to yield a corresponding percentage can be implemented in the form of a suitable event-specific event table record having the desired ratio calculation specified in the TEST TYPE field. The bad card read count and total reader access count would be suitably updated by appropriate diagnostic instructions in the ACTION TYPE field, prior to computation of the percentage value.

The IF-THEN statement specified in the TEST TYPE field will likewise indicate what corrective action to take when the calculated ratio exceeds a certain level specified in the TEST VALUE field. For example, the action (i.e., escalation event) can involve notifying a service technician that the card reader needs cleaning.

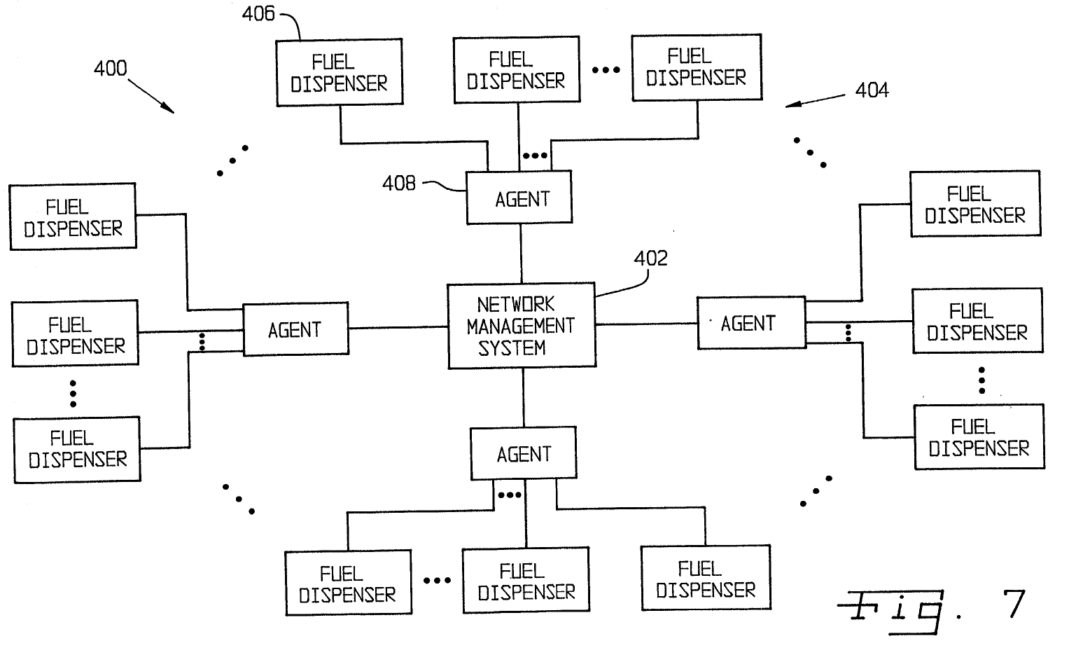

Referring now to FIG. 7, there is shown a block diagram view of a global dispenser management system 400 for networking a centralized system administrator 402 with various refueling environments 404 having dedicated agent facilities 408, according to another example of the invention.

As shown, the illustrated system 400 includes an administrator 402 in the form of a network management system such as a remote management application. Administrator 402 is arranged for communication with a plurality of individual refueling stations 404 each having plural dispenser positions 406.

Each refueling station 404 is equipped with an agent facility 408 having a construction, operation, and functionality similar to that disclosed herein in connection with FIGS. 1-6. Agent 408, for example, supports and otherwise facilitates the administrative actions, services, and other management functions performed in association with network management system 402.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system, comprising:
a fuel dispenser position having a plurality of components; and
an agent facility operatively associated with said fuel dispenser position;
said agent facility being configured to perform a monitoring function and/or a control function relative to said fuel dispenser position.

2. The system as recited in claim 1, wherein said agent facility being configured further to: (i) receive event information from said fuel dispenser position; (ii) process the event information received from said fuel dispenser position; (iii) evaluate and/or analyze the processed event information; (iv) execute a maintenance task in accordance with the results of the evaluation and/or analysis; (v) execute a control task in accordance with the results of the evaluation and/or analysis; or (vi) perform any combination of steps (i)-(v).

3. The system as recited in claim 1, wherein said agent facility being configured further to: (i) perform a diagnostic operation in relation to event information operatively received from said fuel dispenser position; and/or (ii) perform and/or direct a maintenance operation in relation to said fuel dispenser position, in accordance with the outcome of the diagnostic operation.

4. The system as recited in claim 3, wherein the event information includes first data indicative of an event, and second data indicative of status, parameter value, condition, performance measure, or any combination thereof in relation to at least one component of said fuel dispenser position.

5. The system as recited in claim 3, wherein the maintenance operation includes issuing command information adapted to reconfigure at least one component, issuing command information adapted to control at least one functional aspect of a fuel dispensing operation at said fuel dispenser position, issuing and/or scheduling a service call, issuing notification of a maintenance-ready condition, or any combination thereof.

6. The system as recited in claim 1, wherein said agent facility being configured further to: (i) receive from said fuel dispenser position an event message indicative of an event occurring therein and/or event information pertaining to the event indicated by the event message; (ii) manipulate variable information associated with the event indicated by the event message, in accordance with the event message and/or the event information; (iii) evaluate the manipulated variable information; and (iv) execute at least one task in accordance with the evaluation results.

7. The system as recited in claim 6, wherein manipulation of the variable information involves adjustment of an event-related variable and/or an event-related counter, the event-related variable being indicative of an operating parameter and/or an operating condition of said fuel dispenser position, the event-related counter being indicative of a count of event occurrence.

8. The system as recited in claim 6, wherein evaluation of the manipulated variable information involves analyzing the manipulated variable information relative to predetermined test information.

9. The system as recited in claim 6, wherein execution of the at least one task involves directing the performance of at least one control task in said fuel dispenser position.

10. The system as recited in claim 1, further comprises:
a variable table operatively associated with said agent facility, said variable table including a plurality of event-specific records, each record respectively including (i) an event indicator indicative of the respective event associated therewith, and (ii) variable information pertaining to the respective event; and
an event table operatively associated with said agent facility, said event table including a plurality of event-specific records, each record respectively including at least one of: (i) an event field indicative of an event associated with the record; (ii) an action type field providing instructions defining a data processing operation for performance in conjunction with relevant variable information from said variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

11. The system as recited in claim 1, wherein said agent facility further comprises:
a means to receive event information from said fuel dispenser position;
a data facility including a plurality of information elements each associated with a respective event;
a processor, said processor being configured to process at least one information element of said data facility in accordance with the event information received from said fuel dispenser position; and
a rules facility, said rules facility including a plurality of rules each associated with a respective event, each rule respectively defining an evaluation function configured to evaluate the information processed by said processor and/or a tasking function configured to execute at least one task in accordance with results of the evaluation function.

12. The system as recited in claim 11, wherein said rules facility having a programmable feature enabling selective modification of said plurality of rules, selective removal of rules, and/or selective addition of rules.

13. The system as recited in claim 1, wherein said agent facility further comprises:
a means to receive event information from said fuel dispenser position;
a data facility including a plurality of information elements each associated with a respective event;
a processor, said processor being configured to process at least one information element of said data facility in accordance with the event information received from said fuel dispenser position; and
a rules facility, said rules facility including a plurality of rules each associated with a respective event, each rule respectively defining: (i) a diagnostic function configured to perform a diagnostic operation in relation to information processed by said processor; (ii) a maintenance call operation configured to perform and/or direct the execution of at least one maintenance task pertaining to said fuel dispenser position, in accordance with the results of the diagnostic operation; (iii) a control operation configured to perform and/or direct the execution of at least one control task pertaining to said fuel dispenser position, in accordance with the results of the diagnostic operation; or (iv) any combination of (i)-(iii).

14. The system as recited in claim 1, further comprises:
a remote facility including a management application, said remote facility being disposed apart from said fuel dispenser position, said management application being configured to enable management of at least one component of said fuel dispenser position in cooperation with said agent facility; and
a communications link between said agent facility and said remote facility.

15. The system as recited in claim 14, wherein said agent facility including a client entity and said remote facility including a server entity.

16. The system as recited in claim 15, wherein said agent facility and said remote facility being configured to perform management functions according to the Simple Network Management Protocol (SNMP) specification.

17. A system for use in a refueling environment, said refueling environment comprising a plurality of fuel dispenser positions each having a respective plurality of components, said system comprising:
a management system configured to enable operative management of said refueling environment;
said management system including a management application in combination with an agent facility;
said agent facility being operatively arranged in a network management configuration with at least one fuel dispenser position.

18. The system as recited in claim 17, wherein said agent facility being configured to: (i) perform a diagnostic operation in relation to event information operatively received from said refueling environment; and/or (ii) perform and/or direct a maintenance operation in relation to at least one fuel dispenser position, in accordance with the outcome of the diagnostic operation.

19. The system as recited in claim 17, wherein said agent facility being configured to: (i) receive event information from said refueling environment; (ii) process the event information received from said refueling environment; (iii) evaluate and/or analyze the processed event information; (iv) execute a maintenance task in accordance with the results of the evaluation and/or analysis; (v) execute a control task in accordance with the results of the evaluation and/or analysis; or (vi) perform any combination of steps (i)-(v).

20. The system as recited in claim 17, wherein said agent facility being configured to: (i) receive from said refueling environment at least one event message indicative of at least one event occurring therein and/or event information pertaining to the at least one event indicated by the at least one event message; (ii) manipulate variable information associated with the at least one event indicated by the at least one event message, in accordance with the at least one event message and/or the event information; (iii) evaluate the manipulated variable information; and (iv) execute at least one task in accordance with the evaluation results.

21. The system as recited in claim 20, wherein manipulation of the variable information involves adjustment of an event-related variable and/or an event-related counter, the event-related variable being indicative of an operating parameter and/or an operating condition pertaining to at least one fuel dispenser position, the event-related counter being indicative of a count of event occurrence.

22. The system as recited in claim 20, wherein evaluation of the manipulated variable information involves analyzing the manipulated variable information relative to predetermined test information.

23. The system as recited in claim 20, wherein execution of the at least one task involves directing the performance of at least one control task in relation to at least one fuel dispenser position.

24. The system as recited in claim 17, further comprises:
a variable table operatively associated with said agent facility, said variable table including a plurality of event-specific records, each record respectively including an event indicator indicative of the respective event associated therewith and variable information pertaining to the respective event; and
an event table operatively associated with said agent facility, said event table including a plurality of event-specific records, each record respectively including at least one of: (i) an event field indicative of an event associated with the record; (ii) an action type field providing instructions defining a data processing operation for performance in conjunction with relevant variable information from said variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

25. The system as recited in claim 17, wherein said agent facility further comprises:
a means to receive event information from said refueling environment;
a data facility including a plurality of information elements each associated with a respective event;
a processor, said processor being configured to process at least one information element of said data facility in accordance with the event information received from said refueling environment; and
a rules facility, said rules facility including a plurality of rules each associated with a respective event, each rule respectively defining an evaluation function configured to evaluate the information processed by said processor and/or a tasking function configured to execute at least one task in accordance with results of the evaluation function.

26. The system as recited in claim 17, wherein said agent facility further comprises:
a means to receive event information from said refueling environment;
a data facility including a plurality of information elements each associated with a respective event;
a processor, said processor being configured to process at least one information element of said data facility in accordance with the event information received from said refueling environment; and
a rules facility, said rules facility including a plurality of rules each associated with a respective event, each rule respectively defining: (i) a diagnostic function configured to perform a diagnostic operation in relation to information processed by said processor; (ii) a maintenance call operation configured to perform and/or direct the execution of at least one maintenance task in relation to at least one fuel dispenser position, in accordance with the results of the diagnostic operation;(iii) a control operation configured to perform and/or direct the execution of at least one control task in relation to at least one fuel dispenser position, in accordance with the results of the diagnostic operation; or (iv) any combination of (i)-(iii).

27. The system as recited in claim 17, wherein said management application being disposed remote from said refueling environment and said agent facility being disposed within said refueling environment.

28. An apparatus, comprising:
a fuel dispenser position; and
an agent facility operatively associated with said fuel dispenser position.

29. The apparatus as recited in claim 28, wherein said agent facility further comprises:
a means to receive event information from said fuel dispenser position;
a diagnostic test program operatively coupled to said receive means; and
a maintenance procedure program operatively associated with said diagnostic test program.

30. The apparatus as recited in claim 28, wherein said agent facility further comprises:
a means to receive event information from said fuel dispenser position;
a data processor operatively coupled to said receive means; and
a data analyzer operatively coupled to said data processor.

31. The apparatus as recited in claim 28, further comprises:
a fuel dispenser control program operatively associated with said agent facility.

32. The apparatus as recited in claim 28, further comprises:
an event table operatively associated with said agent facility.

33. The apparatus as recited in claim 32, further comprises:
a variable table operatively associated with said event table.

34. The apparatus as recited in claim 33, wherein:
said variable table including a plurality of event-specific records, each record respectively including (i) an event indicator indicative of the respective event associated therewith, and (ii) variable information pertaining to the respective event; and
said event table including a plurality of event-specific records, each record respectively including at least one of: (i) an event field indicative of an event associated with the record; (ii) an action type field providing instructions defining a data processing operation involving variable information from said variable table; (iii) a test type field providing instructions defining an analysis operation in conjunction with results of the data processing operation; (iv) a test value field defining a predetermined test value for use in the analysis operation; and (v) an escalation event field providing instructions defining at least one task for execution depending upon the outcome of the analysis operation.

35. The apparatus as recited in claim 28, wherein said agent facility further comprises:
a means to receive event information from said fuel dispenser position;
a data facility including a plurality of information elements each associated with a respective event;
a processor operatively associated with said receive means and said data facility; and
a rules facility operatively associated with said processor, said rules facility including a plurality of rules each associated with a respective event, each rule respectively including a first set of executable instructions defining an evaluation procedure and a second set of executable instructions defining a management task, the management task including an executable control task and/or an executable maintenance task.

36. The apparatus as recited in claim 28, wherein said agent facility further comprises:
a means to receive event information from said fuel dispenser position;
a data facility including a plurality of information elements each associated with a respective event;
a processor operatively associated with said receive means and said data facility; and
a rules facility operatively associated with said processor, said rules facility including a plurality of rules each associated with a respective event, each rule respectively including (i) first program code defining a diagnostic operation, (ii) second program code defining a maintenance operation in relation to said fuel dispenser position, and (iii) third program code defining a control operation in relation to said fuel dispenser position.

37. The apparatus as recited in claim 28, further comprises:
a remote facility including a management application, said remote facility being disposed apart from said fuel dispenser position; and
a communications link between said agent facility and said remote facility.

38. A method for use with a fuel dispenser position in combination with an agent facility, said method comprising the steps of:
the agent facility receiving event information from said fuel dispenser position;
the agent facility processing the event information received from said fuel dispenser position; and
the agent facility evaluating the processed event information.

39. The method as recited in claim 38, further comprises the steps of:
the agent facility executing a maintenance task and/or a control task in accordance with results of the evaluation.

40. The method as recited in claim 38, further comprises the step of:
the agent facility communicating the event information received from said fuel dispenser position and/or the evaluation results to a remote facility disposed apart from said fuel dispenser position.

41. The method as recited in claim 38, further comprises the step of:
the agent facility issuing control commands to said fuel dispenser position, in response to at least one directive received from a remote facility disposed apart from said fuel dispenser position.

42. The method as recited in claim 38, further comprises the step of:
the agent facility performing at least one management task in relation to said fuel dispenser position, in response to at least one instruction received from a remote management application disposed apart from said fuel dispenser position.

43. The method as recited in claim 38, wherein the processing step further comprises the steps of:
defining event-specific variable information;
associating the variable information with the event information; and
manipulating the variable information in accordance with the event information.

44. The method as recited in claim 43, wherein the manipulation step further comprises the step of:
adjusting an event-related variable and/or an event-related counter, the event-related variable being indicative of an operating parameter and/or an operating condition of said fuel dispenser position, the event-related counter being indicative of a count of event occurrence.

45. The method as recited in claim 38, wherein the evaluation step further comprises the step of:
determining an allowability of the processed event information in comparative relation to reference information.

46. The method as recited in claim 38, wherein the evaluation step further comprises the step of:
performing a rule-based analysis of the processed event information.

47. The method as recited in claim 38, wherein the evaluation step further comprises the steps of:
defining a plurality of event-specific rules;
detecting an event based upon the event information received from said fuel dispenser position; and
applying the processed event information to at least one relevant one of said plurality of event-specific rules as specified by the detected event.

48. The method as recited in claim 47, wherein each rule respectively defining: (i) a diagnostic function configured to perform a diagnostic operation in relation to the processed event information; (ii) a maintenance call operation configured to perform and/or direct the execution of at least one maintenance task pertaining to said fuel dispenser position, in accordance with the results of the diagnostic operation; (iii) a control operation configured to perform and/or direct the execution of at least one control task pertaining to said fuel dispenser position, in accordance with the results of the diagnostic operation; or (iv) any combination of (i)-(iii).

49. The method as recited in claim 47, wherein the rule definition step further comprises the step of:
constructing an event table including a plurality of event-specific records;
each event table record respectively including at least one of: (i) an event field indicative of an event associated with the record; (ii) an action type field providing instructions defining a data processing operation for performance in conjunction with event-specific variable information, the data processing operation being used by the event information processing step; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

50. The method as recited in claim 49, further comprises the step of:
constructing a variable table including a plurality of event-specific records;
each variable table record respectively including (i) an event indicator indicative of the respective event associated therewith, and (ii) event-specific variable information pertaining to the respective event.

51. The method as recited in claim 38, wherein the evaluation step further comprises the steps of:
constructing a variable table including a plurality of event-specific records;
each variable table record respectively including (i) an event indicator indicative of the respective event associated therewith, and (ii) event-specific variable information pertaining to the respective event;
constructing an event table including a plurality of event-specific records, each event table record respectively defining an executable evaluation procedure;
each event table record respectively including at least one of: (i) an event field indicative of an event associated with the record; (ii) an action type field providing instructions defining a data processing operation for performance in conjunction with relevant variable information from the variable table, the data processing operation being used by the event information processing step; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation; and
utilizing the event table and the variable table to evaluate the processed event information by associating an event indicated by the event information with a relevant event-specific event table record and executing the corresponding evaluation procedure defined by the relevant event table record.

52. A method for use with a fuel dispenser position in combination with an agent facility, said method comprising the steps of:
the agent facility receiving event information from said fuel dispenser position; and
the agent facility performing a diagnostic test procedure in relation to the event information received from said fuel dispenser position.

53. The method as recited in claim 52, further comprises the step of:
the agent facility performing a maintenance operation and/or a control operation in relation to said fuel dispenser position, in accordance with the results of the diagnostic test procedure performance.

54. The method as recited in claim 52, wherein the diagnostic test procedure performance step further comprises the steps of:
defining a plurality of event-specific rules;
detecting an event based upon the event information received from said fuel dispenser position; and
causing at least one relevant one of said plurality of event-specific rules as specified by the detected event to process and/or evaluate the event information.

55. The method as recited in claim 54, wherein the rule definition step further comprises the step of:
constructing an event table including a plurality of event-specific records;
each event table record respectively including at least one of: (i) an event field indicative of an event associated with the record; (ii) an action type field providing instructions defining a data processing operation for performance in conjunction with event-specific variable information; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation.

56. The method as recited in claim 55, further comprises the step of:
constructing a variable table including a plurality of event-specific records;
each variable table record respectively including (i) an event indicator indicative of the respective event associated therewith, and (ii) event-specific variable information pertaining to the respective event.

57. The method as recited in claim 52, wherein the diagnostic test procedure performance step further comprises the steps of:
defining event-specific variable information;
associating the variable information with the event information;
manipulating the variable information in accordance with the event information; and
evaluating the manipulated variable information.

58. The method as recited in claim 57, wherein the manipulation step further comprises the step of:
adjusting an event-related variable and/or an event-related counter, the event-related variable being indicative of an operating parameter and/or an operating condition of said fuel dispenser position, the event-related counter being indicative of a count of event occurrence.

59. The method as recited in claim 52, further comprises the step of:
the agent facility communicating the event information received from said fuel dispenser position and/or the evaluation results to a remote facility disposed apart from said fuel dispenser position.

60. The method as recited in claim 52, further comprises the step of:
the agent facility issuing control commands to said fuel dispenser position, in response to at least one directive received from a remote facility disposed apart from said fuel dispenser position.

61. The method as recited in claim 52, further comprises the step of:
the agent facility performing at least one management task in relation to said fuel dispenser position, in response to at least one instruction received from a remote management application disposed apart from said fuel dispenser position.

62. A computer program product for use in an agent facility having a computer environment, the agent facility operatively associated with a fuel dispenser position, the computer program product comprising a computer usable medium having computer readable program code thereon executable by the computer environment, the computer readable program code comprising:
first program code for processing event information operatively received by said agent facility from said fuel dispenser position; and
second program code for evaluating the processed event information.

63. The computer program product as recited in claim 62, wherein the computer readable program code further comprises:
program code for executing a maintenance task and/or a control task relative to said fuel dispenser position, in accordance with the results of the evaluation provided by the second program code.

64. The computer program product as recited in claim 62, wherein the computer readable program code further comprises:
program code for defining a plurality of executable event-specific rules;
program code for detecting an event based upon the event information received from said fuel dispenser position; and
program code for applying the processed event information to at least one relevant one of said plurality of event-specific rules as specified by the detected event for execution thereof.

65. The computer program product as recited in claim 62, further comprises:
a first data facility including a variable table having a plurality of event-specific records;
each variable table record respectively including (i) an event indicator indicative of the respective event associated therewith, and (ii) event-specific variable information pertaining to the respective event;
a second data facility including an event table having a plurality of event-specific records, each event table record respectively defining an executable evaluation procedure;
each event table record respectively including at least one of: (i) an event field indicative of an event associated with the record; (ii) an action type field providing instructions defining a data processing operation for performance in conjunction with relevant variable information from the variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation; and
the second program code further includes third program code for utilizing the event table and the variable table to evaluate the processed event information by associating an event indicated by the event information with a relevant event-specific event table record and then executing the corresponding evaluation procedure defined by the relevant event table record.

66. A computer program product for use in an agent facility having a computer environment, the agent facility operatively associated with a fuel dispenser position, the computer program product comprising a computer usable medium having computer readable program code thereon executable by the computer environment, the computer readable program code comprising:
first program code for defining and performing a diagnostic test procedure in relation to event information received from said fuel dispenser position.

67. The computer program product as recited in claim 66, wherein the computer readable program code further comprises:
program code for performing a maintenance operation and/or a control operation in relation to said fuel dispenser position, in accordance with the results of the diagnostic test procedure performance provided by said first program code.

68. The computer program product as recited in claim 66, wherein the first program code further comprises:
program code for defining a plurality of executable event-specific rules;
program code for detecting an event based upon the event information received from said fuel dispenser position; and
program code for causing at least one relevant one of said plurality of event-specific rules as specified by the detected event to process and/or evaluate the event information by execution thereof.

69. The computer program product as recited in claim 66, wherein the first program code further comprises:
second program code for defining event-specific variable information;
third program code for associating the variable information with the event information;
fourth program code for manipulating the variable information in accordance with the event information; and
fifth program code for evaluating the manipulated variable information.

70. The computer program product as recited in claim 69, wherein the fourth program code further comprises:
program code for adjusting an event-related variable and/or an event-related counter, the event-related variable being indicative of an operating parameter and/or an operating condition of said fuel dispenser position, the event-related counter being indicative of a count of event occurrence.

71. The computer program product as recited in claim 66, further comprises:
a first data facility including a variable table having a plurality of event-specific records;
each variable table record respectively including (i) an event indicator indicative of the respective event associated therewith, and (ii) event-specific variable information pertaining to the respective event;
a second data facility including an event table having a plurality of event-specific records, each event table record respectively defining an executable evaluation procedure;
each event table record respectively including at least one of: (i) an event field indicative of an event associated with the record; (ii) an action type field providing instructions defining a data processing operation for performance in conjunction with relevant variable information from the variable table; (iii) a test type field providing instructions defining an analysis operation for performance in conjunction with results of the data processing operation; (iv) a test value field defining a predetermined test value for use in the analysis operation; and (v) an escalation event field providing instructions defining at least one task for execution depending upon the outcome of the analysis operation; and
the first program code further includes program code for utilizing the event table and the variable table to process and evaluate the event information by associating an event indicated by the event information with a relevant event-specific event table record and then executing the corresponding evaluation procedure defined by the relevant event table record.
